(19) United States
(12) Patent Application Publication
(10) Pub. No.: US 2026/0009244 A1
(43) Pub. Date: Jan. 8, 2026

(54) EXPANDABLE MULTIFUNCTIONAL INTEGRATED-CONSTRUCTION SKYSCRAPER BUILDING PLATFORM AND CONSTRUCTION METHOD USING SAME

(71) Applicant: WUHAN CONSTRUCTION ENGINEERING GROUP CO., LTD., Wuhan (CN)

(72) Inventors: Shuai WANG, Wuhan (CN); Wenxiang LI, Wuhan (CN); Aixun WANG, Wuhan (CN); Mingzhao WANG, Wuhan (CN); Tong LU, Wuhan (CN); Ming YOU, Wuhan (CN); Lin WANG, Wuhan (CN); Ying LIU, Wuhan (CN); Li WANG, Wuhan (CN); Keyang WU, Wuhan (CN); Bo WANG, Wuhan (CN); Jianhui WU, Wuhan (CN); Bangfeng XI, Wuhan (CN); Lei ZHAO, Wuhan (CN); Xin FAN, Wuhan (CN); Cong WANG, Wuhan (CN); Wenhui XIONG, Wuhan (CN); Zhendong DU, Wuhan (CN); Yiou YANG, Wuhan (CN); Chen QIAN, Wuhan (CN); Wei YANG, Wuhan (CN); Chen LIU, Wuhan (CN)

(73) Assignee: WUHAN CONSTRUCTION ENGINEERING GROUP CO., LTD., Wuhan (CN)

(21) Appl. No.: 18/995,850

(22) PCT Filed: Dec. 26, 2023
(86) PCT No.: PCT/CN2023/141930

§ 371 Date: Jan. 17, 2025

(30) Foreign Application Priority Data
Feb. 13, 2023 (CN) 202310106723.9

(51) Int. Cl. E04G 21/16; B66B 9/00; B66C 17/00; B66C 23/20; E02D 7/06; E02D 27/10; E04G 1/22; E04G 21/04; E04G 21/24

(52) U.S. Cl. CPC E04G 21/16; B66B 9/00; B66C 17/00; B66C 23/20; E02D 7/06; E02D 27/10; E04G 1/22; E04G 21/04; E04G 21/24

(57) ABSTRACT

An expandable multifunctional integrated-construction skyscraper building platform and a construction method using the same are provided. The expandable multifunctional integrated- construction skyscraper building platform includes: a building foundation part, including an underground level, a basement level and a ground level which form a main body; an external frame part, a bottom of the external frame part being fixed deep into the underground level, and a top of the external frame part running through the basement level and the ground level to reach upper air such that lifting platform parts arranged on the external frame part are capable of going up from the underground level for construction; a transportation elevator part and a three-layer enclosure part, mounted on the building foundation part; a top transfer part, mounted on a Chinese character “Ri” frame at a top of the external frame part; and a carrying tower.

### CROSS-REFERENCE TO THE RELATED APPLICATIONS

This application is the national phase entry of International Application No. PCT/CN2023/141930, filed on Dec. 26, 2023, which is based upon and claims priority to Chinese Patent Application No. 202310106723.9, filed on Feb. 13, 2023, the entire contents of which are incorporated herein by reference.

### TECHNICAL FIELD

The disclosure relates to the technical field of construction engineering, and in particular to an expandable multifunctional integrated-construction skyscraper building platform and a construction method using the expandable multifunctional integrated-construction skyscraper building platform.

### BACKGROUND

The existing storied building construction method is relatively rudimentary. The construction site covers a large area, and there are many construction materials and machines piled up, which leads to a harsh construction environment. On-site construction mostly uses manual labor, and there is an insufficient proportion of mechanical construction. With the aggravation of population aging, the construction industry is facing the problems of a shortage of labor workers, high employment cost and uneven quality of workers. Moreover, the messy passage routes and surrounding environment on the site are not convenient for construction. There is a waste of construction machines such as repeated handling of materials, which makes it even more inconvenient to use construction robots.

In the building foundation construction stage, the site usually needs to be excavated, and there is a large amount of muck that needs to be removed. On the site, a typical method to handle earth is to provide foundation pit slopes in combination with excavators and muck trucks which operate in the foundation pit excavated area, which is very efficient. However, the earth carried by the tires of the muck trucks needs to be cleaned before being transported out, and makes the city roads dirty. For example, at present, when the main structure is under construction, since the internal passages of the building are not completed, in order to facilitate the workers to go up and down, scaffolding anchored to the ground is usually used to build internal passages and construction elevators to serve as worker passages on the periphery of the building. This method needs to build lots of frame structures, which makes the cost higher. Moreover, the scaffolding needs to be connected to the walls of the building, which may damage the building to some extent, causing water seepage and other problems. For another example, when the main structure is under construction, the external wall of the building is not completed, and a climbing screen is usually provided as the safety enclosure structure on the construction floor.

Generally speaking, in the above environments, many construction methods have the defects of non-integrated construction, non-standard space and high difficulty in control, are not intelligent enough, and are difficult for arranging sensors to perform intelligent control on the construction site. However, skyscraper building machines use intelligent construction technology, and will become the trend of storied building construction in future. Chinese application No. CN202011581253.4 discloses a skyscraper building machine and a building construction method. In this patent, all technical processes are centrally completed in air floor by floor, so that the labor intensity of workers is reduced. However, this skyscraper building machine has to be attached to the floor, so it is highly dependent on the building and still needs to be improved in terms of transportation of construction materials and machines.

### SUMMARY

In view of the defects in the prior art, the technical problem to be solved by the disclosure is to provide an expandable multifunctional integrated-construction skyscraper building platform and a construction method using the same. Through attachment to a periphery of a building and expansion, the disclosure realizes self-loop transportation inside the building and expanded loop transportation outside the building, thereby effectively improving the in-air transportation and construction efficiency. Moreover, in-air pile driving, earth excavation and transportation, and concrete pouring systems are provided.

In order to achieve the above objective, the disclosure adopts the following technical measures:

The expandable multifunctional integrated-construction skyscraper building platform of the disclosure includes: a building foundation part, including an underground level, a basement level and a ground level which form a main body, and configured to serve as a bottom support of the whole platform; an external frame part, mounted on the building foundation part, a bottom of the external frame part being fixed deep into the underground level, and a top of the external frame part running through the basement level and the ground level to reach upper air such that lifting platform parts arranged on the external frame part are capable of going up from the underground level for construction; a transportation elevator part, mounted on the building foundation part, and including a vertical rectangular frame which is formed by fourth standard sections and forms a main body, two construction elevators being arranged inside two vertical sides of the vertical rectangular frame and movable on tracks formed by the fourth standard sections so as to transport workers, robots and construction materials to higher floors; a three-layer enclosure part, mounted on the external frame part, and including a three-layer Chinese character “Hui” enclosure baffle which forms a main body, an inner side of the three-layer Chinese character “Hui” enclosure baffle being provided with a Chinese character “Hui” bottom supporting plate, a Chinese character “Hui” passageway being mounted on top of the bottom supporting plate, middle passageways and access aisles being arranged in a middle of the Chinese character “Hui” passageway, and the construction elevators being capable of reaching a height of the access aisles; a top transfer part, mounted on a Chinese character “Ri” frame at the top of the external frame part, left and right tracks of the Chinese character “Ri” frame being provided with second slide rails, mobile trolleys being arranged on the second slide rails, gantry crane structures formed by a plurality of fifth standard sections being arranged on the mobile trolleys; a carrying tower, mounted on the external frame part; a hammer-type pile driving system, mounted to the carrying tower, and configured to clamp a steel pile, move the steel pile to a preset position and hammer the steel pile into earth by means of a hammering part; and a tower-wall concrete pouring system, mounted on the carrying tower, and configured to pump concrete on the ground level to a construction area and perform concrete pouring.

Preferably, the external frame part includes six first standard sections which form a bottom support and are mounted on the underground level, and a plurality of second standard sections are mounted on the six first standard sections. The construction area formed by the six first standard sections is divided into a building construction area and a material conveying area, respectively formed by every four adjacent first standard sections. A vertical standard section column formed by a plurality of third standard sections runs through a middle of a top of the second standard section, and is movable up and down through an actuator. Tops of every two vertical standard section columns are connected through horizontal third standard sections to form the Chinese character “Ri” frame. Vertical columns formed by the second standard sections are each provided with a first slide rail on an outer side, a winch on a top and a first supporting rod on an inner side. The first slide rails are provided with two lifting platform parts which are pullable by the winches to realize height adjustment on the first slide rails. The other end of the first supporting rod is fixed to a surface of a building such that the whole external frame part is attached to the building.

Further, a middle cross passageway formed by the middle passageways and the access aisles are capable of being installed or removed in advance. When the whole three-layer enclosure part moves to above a top of the building, the middle cross passageway is capable of being installed, and when the whole three-layer enclosure part moves to below the top of the building, the middle cross passageway is capable of being removed, so that the three-layer enclosure part is capable of enclosing the whole building for maintenance. The three-layer Chinese character “Hui” enclosure baffle sequentially includes an operation layer, a maintenance layer and an enclosure layer from top to bottom. Through cooperation between the three-layer Chinese character “Hui” enclosure baffle and the passageways inside, the construction robots and the construction materials are transported from a bottom into the access aisles through the transportation elevator part so as to enter the Chinese character “Hui” passageway inside the three-layer Chinese character “Hui” enclosure baffle for building construction.

Preferably, the carrying tower includes tower standard sections, a hydraulic station a and an I-beam slideway. The hydraulic station a provides power for oil cylinders of the hammer-type pile driving system and includes an oil storage tank, a first motor, a controller, a hydraulic pump, a solenoid valve group and a servo valve, the first motor is connected to a tower crane through a wire and powered by the tower crane to drive the hydraulic pump to generate high-pressure hydraulic oil, and the servo valve adjusts a pressure and a flow of the high-pressure hydraulic oil. The controller remotely controls the servo valve and the solenoid valve group to be on or off. The I-beam slideway includes slide rail trolleys, hinge supports a, an I-beam track a and an I-beam track b, the I-beam track a and the I-beam track b are fixed to a side surface of the tower standard sections by welding, the slide rail trolleys are mounted on the I-beam track a and the I-beam track b, and a base of the hinge support a is fixedly connected to a base of the slide rail trolley through bolts.

Preferably, the hammer-type pile driving system includes a connecting support, a multi-degree-of-freedom articulated arm, the hammering part and hydraulic pile clamping parts. The connecting support is configured to support and fix the multi-degree-of-freedom articulated arm to ensure stable movement of the hammer-type pile driving system. The multi-degree-of-freedom articulated arm drives articulated arms to complete corresponding actions through hydraulic cylinders. The hammering part lifts a hammer through a hydraulic winch and releases the hammer to hammer the steel pile, and the hammer repeatedly hammers the steel pile, thereby completing a pile driving process. The plurality of hydraulic pile clamping parts work at the same time, and a hydraulic cylinder drives a clamping mechanism to clamp the steel pile and controls the multi-degree-of-freedom articulated arm to move the steel pile, adjust an orientation of the steel pile and stably insert the steel pile into a foundation pit, thereby reducing a clamping force of the hydraulic cylinder of the hydraulic pile clamping part and ensuring the steel pile to be smoothly hammered into the earth.

Further, the connecting support includes hinge supports b, a supporting steel plate, a swingarm hydraulic cylinder a, a swingarm hydraulic cylinder b, a heavy-duty hinge support and a U-shaped swingarm. The supporting steel plate is used as a basic base of the hammer-type pile driving system, the hinge supports b are fixed to a back side of the supporting steel plate, and pin holes of the two rows of the hinge supports b have axes perpendicular to each other and are connected to the hinge supports a through hinge pins. The heavy-duty hinge support is welded and fixed to a middle position of a front side of the supporting steel plate and is capable of carrying a weight of the whole hammer-type pile driving system, a pin hole at one end of the U-shaped swingarm is connected to the heavy-duty hinge support through a hinge pin, and two sides of the U-shaped swingarm are provided with small pin holes respectively hinged with retractable ends of the swingarm hydraulic cylinder a and the swingarm hydraulic cylinder b. Cylinder tails of the swingarm hydraulic cylinder a and the swingarm hydraulic cylinder b are connected to pin hole seats fixed to two sides of the supporting steel plate through hinge pins, and the U-shaped swingarm is controlled by the swingarm hydraulic cylinder a and the swingarm hydraulic cylinder b to rotate around an axis of a pin hole of the heavy-duty hinge support such that the multi-degree-of-freedom articulated arm rotates left and right.

Preferably, the multi-degree-of-freedom articulated arm includes an articulated arm oil cylinder hinge seat a, an articulated arm oil cylinder a, a first articulated arm, an articulated arm oil cylinder hinge seat b, an articulated arm oil cylinder b, a second articulated arm, an articulated arm oil cylinder c, an arc-shaped link, a straight link and a steel plate. The articulated arm oil cylinder hinge seat a is welded and fixed to an upper part of the U-shaped swingarm, the articulated arm oil cylinder hinge seat a is rotatable along with the U-shaped swingarm, a pin hole at one end of the first articulated arm is hinged with a pin hole at a lower part of the articulated arm oil cylinder hinge seat a through a hinge pin, a pin hole at the other end is hinged with a pin hole of the second articulated arm through a hinge pin, and a pin hole at an upper part of the first articulated arm is hinged with a retractable end of the articulated arm oil cylinder a through a hinge pin. A cylinder tail of the articulated arm oil cylinder a is hinged with a pin hole at an upper part of the articulated arm oil cylinder hinge seat a through a hinge pin, and extension and retraction of the articulated arm oil cylinder a control a lifting action of the first articulated arm. The articulated arm oil cylinder hinge seat b is welded and fixed below the first articulated arm, a cylinder tail of the articulated arm oil cylinder b is hinged with a pin hole at an end portion of the articulated arm oil cylinder hinge seat b through a hinge pin, a retractable end of the articulated arm oil cylinder b is hinged with a pin hole at a lower part of the second articulated arm through a hinge pin, and extension and retraction of the articulated arm oil cylinder b control a lifting action of the second articulated arm. A pin hole at an upper part of the second articulated arm is hinged with a cylinder tail of the articulated arm oil cylinder c through a hinge pin, a retractable end of the articulated arm oil cylinder c is hinged with a pin hole at one end of the arc-shaped link and a pin hole at one end of the straight link through a hinge pin, another pin hole of the arc-shaped link is hinged with a middle pin hole of the second articulated arm through a hinge pin, another pin hole of the straight link is hinged with a pin hole at an upper part of the steel plate through a hinge pin, and extension and retraction of the articulated arm oil cylinder c control a pitching action of the steel plate.

Further, the hammering part includes a hammer guide rod, a steel frame, a hammer, the steel pile, a hoisting mechanism and a guide rod lifting mechanism. The steel frame is used as a fixed base of the hammer-type pile driving system, and the hammer guide rod is an alloy long rod running through the guide rod lifting mechanism which controls a lifting height of the hammer guide rod. The hammer is a steel cylinder with a circular hole at a center, two ends of the circular hole are provided with linear bearings, the hammer guide rod runs through the circular hole, the hammer is slidable up and down along the hammer guide rod, and an upper part of the hammer is provided with an iron ring which is connected to the hoisting mechanism through a wire rope and a pulley block such that the hammer is capable of being lifted and released. When the hammer is released and falls along the hammer guide rod, the clamping force of the hydraulic cylinder of the hydraulic pile clamping part is reduced until the hammer hits the steel pile to ensure the steel pile to be smoothly hammered into the earth. After the hitting, the hoisting mechanism lifts the hammer to a certain height through the wire rope and then releases the hammer again, and the hitting process is repeated until the steel pile is driven into the earth. The hoisting mechanism includes a hydraulic motor a, a reducer a, an electromagnetic clutch, a wire rope reel, a reel fixing support, a short I-beam a, a pulley a, a pulley b, a pulley c, a short I-beam b and a linear bearing, the hydraulic motor a is provided with a hydraulic oil pressure by the hydraulic station a and converts the hydraulic oil pressure into a rotating motion, the hydraulic motor a is fixed to the steel frame through bolts, an output shaft of the hydraulic motor a is connected to an input shaft of the reducer a, and the reducer a is mounted to a side surface of the hydraulic motor a through bolts. One side of the electromagnetic clutch is fixedly mounted to an output shaft of the reducer a, the other side is fixedly mounted to a side surface of the wire rope reel, the electromagnetic clutch controls whether power of the output shaft of the reducer a is outputted to the wire rope reel by controlling power engagement and disengagement of the clutch through closing and opening of an input circuit, the reel fixing support is fixed to the steel frame through bolts, and a ball bearing therein forms an interference fit with a rotating shaft of the wire rope reel to support and constrain the wire rope reel so as to ensure stable rotation of the wire rope reel. The short I-beam a is fixed to a top end of the steel frame, the pulley a is fixed to an end portion of the short I-beam a, the pulley b is fixed to a top of the short I-beam a, a middle of the short I-beam b is provided with a circular hole which is used for fixing the linear bearing and for the hammer guide rod to run through, a square hole of the short I-beam b is used for fixing the pulley c and for the wire rope to run through, a flat surface of the short I-beam b faces up, and one end of the short I-beam b is fixed to an end portion of the short I-beam a by welding. The pulley c is fixed beside the square hole in the middle of the short I-beam b through bolts, the iron ring of the hammer is connected to the wire rope reel through the wire rope across the pulley c, the pulley b and the pulley a, and forward and reverse rotation of the wire rope reel are capable of winding up or releasing the wire rope such that the hammer is capable of rising and falling. The hydraulic pile clamping part is hydraulically driven to clamp the steel pile so as to handle the steel pile and adjust a position of the steel pile, and the hydraulic pile clamping part includes a hydraulic clamp base, a hydraulic clamp oil cylinder hinge support, a hydraulic clamp oil cylinder, a curved steel jaw a, a curved steel jaw b and a centering clamping mechanism. The hydraulic clamp base is a rectangular steel frame with a hollow space in a middle and is fixed to a top of the steel frame through bolts, the hydraulic clamp oil cylinder hinge support is fixed to an end portion of the hollow space in the middle of the hydraulic clamp base, a cylinder tail of the hydraulic clamp oil cylinder is hinged with a pin hole of the hydraulic clamp oil cylinder hinge support through a hinge pin, and a retractable end of the hydraulic clamp oil cylinder is fixedly connected to one end of the curved steel jaw a through a Y-shaped joint. Extension and retraction of the hydraulic clamp oil cylinder are capable of driving the curved steel jaw a to move along an axial direction of the hydraulic cylinder, and force of the curved steel jaw a is transferred to the curved steel jaw b through the centering clamping mechanism, such that the curved steel jaw b synchronously moves oppositely along the axial direction of the hydraulic cylinder, and thereby the curved steel jaw a and the curved steel jaw b move toward the center and clamp the steel pile. An anti-collision rod is a steel cylinder whose left end is fixed to an inner side of the curved steel jaw a by welding, the curved steel jaw b is provided with a circular hole for the anti-collision rod to run through, the anti-collision rod is not interfered with when moving with the curved steel jaw a along the axial direction, and the anti-collision rod is configured to abut against the steel pile when the steel pile is clamped so as to prevent the steel pile from contacting the centering clamping mechanism and protect the centering clamping mechanism.

Preferably, the tower-wall concrete pouring system includes a fixed bottom plate, hinge supports c, a hydraulic station b, a concrete pouring part and a concrete screw conveyor, the hydraulic station b provides power for actions of the tower-wall concrete pouring part, and the tower-wall concrete pouring system is movable on slide rails of the tower standard sections. The concrete pouring part includes a four-legged base, a hydraulic turntable, a counterweight, a concrete pump, a concrete conveying duct, an articulated boom and a hydraulic cylinder b, the four-legged base is used as a base of the concrete pouring part and fixed to a top of the fixed bottom plate through bolts, and the hydraulic turntable is fixed to a top of the four-legged base and has functions of rotation and supporting. The articulated boom is a foldable cantilever, the concrete conveying duct is fixed to a side surface along the articulated boom, and a structure formed is the same as a cantilever structure of a concrete pump truck. The counterweight is configured to counterbalance a moment of the cantilever when the cantilever is unfolded so as to ensure a relative balance of the tower, the concrete pump is powered from the tower crane, an input port of the concrete pump is connected to an output port of the concrete screw conveyor through a rubber hose and a concrete conveying steel pipe, the concrete conveying steel pipe is fixable to a side wall of a vertical tower and arranged along the tower standard sections, and the concrete pump and the concrete screw conveyor jointly pump concrete to the concrete conveying duct for pouring. The concrete screw conveyor includes a second motor, a motor reducer, a belt drive mechanism, a screw shaft, a concrete bin, a ground conveying duct and a concrete discharge port, the second motor is fixed to a side wall of the concrete bin, the motor reducer is connected to the second motor through bolts, an output shaft of the second motor is connected to an input shaft of the motor reducer, power is transmitted to an input end of the screw shaft through the belt drive mechanism so as to drive the screw shaft to rotate, the screw shaft is fixed through a bearing and runs through the ground conveying duct, the concrete discharge port is connected to the concrete conveying duct, and when the concrete is added to the concrete bin, the screw shaft rotates to convey the concrete to the tower-wall concrete pouring system through the ground conveying duct, the rubber hose and the concrete conveying steel pipe for pouring; and a plurality of concrete pumps connected in series are installed on a platform of a standard section tower according to a conveying height.

Correspondingly, the construction method using the expandable multifunctional integrated-construction skyscraper building platform provided by the disclosure includes the following steps:
S1: during transportation and construction on a surface of a building, lowering a whole lifting platform part to a basement level or a ground level, allowing construction robots or construction workers to enter a Chinese character “Hui” lifting platform to prepare for operations, lifting the lifting platform part to a specified floor, and allowing the construction robots to move and operate in tracks of the Chinese character “Hui” lifting platform;
S2: during internal transportation and construction on a top of the building, lowering a transportation elevator part to the basement level or the ground level, allowing the construction robots to enter construction elevators, lifting the construction elevators to a height of an access aisle, allowing the robots to enter the three-layer enclosure part through the aisle to perform building construction, and lowering the construction elevators for loop transportation, where the three-layer enclosure part is provided with three access aisles respectively corresponding to construction of three layers, and the robots with different functions are dispatched for construction operation according to needs of operation, maintenance and enclosure;
S3: during external transportation and construction on the top of the building, placing required construction materials or prefabricated components in a lifting area formed by an external frame part in front of the building, moving two gantry crane structures on a top of the external frame part to above the lifting area, lowering lifting hooks, locking the prefabricated components, pulling the prefabricated components up to a specified height by winches such that the prefabricated components pass through the top of the building and reach a construction area of a Chinese character “Ri” frame, moving the two gantry crane structures to specified positions, placing the prefabricated components to specified positions on the top of the building, repeating the above process for transportation and construction, and at the same time, using two auxiliary tower cranes on two sides of a top of the construction area of the Chinese character “Ri” frame to transfer light materials into the top of the building in real time; and
S4: mounting a carrying tower, a hammer-type pile driving system, hydraulic claws and a tower-wall concrete pouring system, where the carrying tower is configured to carry and fix the hammer-type pile driving system and the tower-wall concrete pouring system, and the hammer-type pile driving system is configured to clamp a steel pile, move the steel pile to a preset position and hammer the steel pile into earth by means of a hammering part; the tower-wall concrete pouring system is mounted on tower standard sections and is capable of pumping concrete on the ground level to a construction area covered by the tower so as to perform pouring in place of a traditional pump truck; and the hydraulic claws are mounted to the lifting hooks of a lifting platform, and a hydraulic station drives the hydraulic claws to complete excavation and transportation of the earth in the construction area.

Thereby, the expandable multifunctional integrated-construction skyscraper building platform and the construction method using the same according to the disclosure have the following beneficial effects:
1. Compared with the prior art, the bottom of the external frame part in the disclosure is fixed deep into the underground level, and the top of the external frame part runs through the basement level and the ground level to reach upper air such that the lifting platform parts arranged on the external frame part are capable of going up from the underground level for construction. Since the building is located on top of the basement level, the whole building can be constructed upward from the underground level, thereby effectively widening the construction range. Moreover, since the lifting platform parts can reach the ground level and the basement level, the construction robots can enter the lifting platform parts more conveniently, which can be lifted for construction operation.
2. The lifting platform part of the disclosure includes the Chinese character “Hui” lifting platform which forms the main body. The shape of the Chinese character “Hui” lifting platform can be designed in advance according to the actual shape of the building, so that the tracks are always closely attached to the surface of the building and the construction robots on the lifting platform can perform construction smoothly on the surface of the building.
3. Compared with the structure simply attached to a periphery of the building in the prior art, standard section combinations and supporting rods are designed on the periphery of the building in the disclosure, so that the external frame part of the lifting platform is effectively attached to the building. With the slidable tracks on the standard sections, the construction robots can perform effective construction while being closely attached to the building, thereby improving the efficiency. Moreover, in the disclosure, the two-standard-section combination arranged on the outer side of the original four-standard-section combination forms a Chinese character “Ri” expanded combination, so that the frame part can not only be attached to the surface of the building, but also obtain a huge external expanded space which can be used for storing prefabricated components, construction materials, construction waste and the like, thereby effectively increasing the space utilization. Besides, this external space for storage can greatly reduce the material transportation and handling cost.
4. Compared with the prior art, with the rectangular fourth standard section combination designed in the disclosure, the construction elevators can move between the building foundation part and the three-layer enclosure part, so that the construction robots, the construction workers and the construction materials can be efficiently transported to higher floors from the inside, thereby improving the transportation efficiency. Moreover, the construction elevators can be used as discharge ports to quickly transport the construction waste from high places to the outside.
5. In the disclosure, through the cooperation between the three-layer enclosure structure combination and the passageways inside, the construction robots and the construction materials can be directly transported from the bottom into the access aisle through the transportation elevator part and further enter the Chinese character “Hui” passageway inside the Chinese character “Hui” enclosure baffle so as to construct the building, thereby improving the material transportation and construction efficiency. Thus, this platform can perform structured construction from top to bottom, i.e., performing operation at the top, maintenance in the middle and enclosure at the bottom. After the operation at the top is completed, the whole platform can be moved up, so that the maintenance can be performed in the middle. After a specified time, the maintenance is completed, and then the platform is moved up, such that the enclosure is performed at the bottom layer. In this way, the time utilization is maximized, the efficiency is improved, and the cost is reduced.
6. Compared with the traditional tower crane, the two gantry crane structures on the top in the disclosure can lift heavy objects easily and more stably. Since the building construction area and the material conveying area are provided in the disclosure, the two gantry crane structures can transport the construction materials from the ground level to the top of the high-rise building quickly and efficiently. Since the gantry crane structures can lift the heavy objects, PC prefabricated components such as prefabricated rooms can be lifted directly, which can greatly improve the construction efficiency. Moreover, there are two auxiliary tower cranes that can lift light materials to the top of the building. Through the combination of expanded external transportation and internal transportation, the efficient cooperation between machinery and humans can be realized, thereby improving the overall conveying efficiency.
7. The expanded carrying tower can be quickly mounted and connected to construct a multiaxial mobile platform for supporting and mounting auxiliary construction modules, so that multiple function modules can be mounted and removed quickly, thereby improving the construction efficiency, achieving multiple purposes in one machine and reserving a mounting platform for subsequent development of construction modules.
8. The hammer-type pile driving system, which is used in place of a pile driver, is configured to clamp the steel pile, move the steel pile to the preset position and hammer the steel pile into the earth by means of the hammering part. The hammer-type pile driving system can work in place of the traditional pile driver and realize remotely controlled all-round full-coverage specific-position pile driving, thereby reducing the construction cost. The in-air pile driving used in the disclosure is applicable to complex environments such as swamps. In the construction area where vehicles cannot enter, construction processes such as in-air pile driving, excavation and handling are used so as to reinforce the ground level in the construction area.
9. The hydraulic claw, which is a mobile tower crane transportation claw, can be mounted on the lifting hook of the lifting platform, and can be driven by the hydraulic station to complete earth excavation and transportation in the construction area by means of in-air lifting. The hydraulic claw can realize earth and cargo transportation on rough ground and earth transportation in the area, which can save the muck truck from carrying the earth and improve the construction efficiency.
10. The tower-wall concrete pouring system mounted on the tower standard sections can pump the concrete on the ground level to the construction area covered by the tower so as to perform pouring in place of the traditional pump truck, so that the tower-wall concrete pouring system is wider in coverage and more flexible to use and can pour concrete without dead angles.

### BRIEF DESCRIPTION OF THE DRAWINGS

The accompanying drawings described herein are intended to provide a further understanding of this application and constitute a part of this application, and exemplary examples and descriptions of this application are used to explain this application and do not constitute an improper limitation to this application.

FIG. 1 is a schematic overall structural view of the disclosure;

FIG. 2 is a schematic structural view of a building foundation part according to the disclosure;

FIG. 3 is a schematic structural view of an external frame part and lifting platform parts according to the disclosure;

FIG. 4 is a schematic structural view of a transportation elevator part according to the disclosure;

FIG. 5 is a schematic structural view of a three-layer enclosure part according to the disclosure;

FIG. 6 is a schematic structural view of a top transfer part according to the disclosure;

FIG. 7 a general assembly view of a pile driving part according to the disclosure;

FIG. 8 is a structural view of a carrying tower according to the disclosure;

FIG. 9 is a structural view of tower standard sections according to the disclosure;

FIG. 10 is a structural view of a hydraulic station according to the disclosure;

FIG. 11 is a structural view of an I-beam slideway according to the disclosure;

FIG. 12 is a structural view of an I-beam slide rail trolley according to the disclosure;

FIG. 13 is an assembly view of a multi-degree-of-freedom articulated arm according to the disclosure;

FIG. 14 is a structural view of an articulated arm fixing base according to the disclosure;

FIG. 15 is a structural view of an articulated arm part according to the disclosure;

FIG. 16 is a structural view of a hammer-type pile driving system according to the disclosure;

FIG. 17 is a structural view of a hammer lifting system according to the disclosure;

FIG. 18 is a structural view of a steel frame according to the disclosure;

FIG. 19 is a structural view of a pulley block of a hammering part according to the disclosure;

FIG. 20 is a structural view of a hammer guide rod lifting system according to the disclosure;

FIG. 21 is a detailed view of a hammer guide rod lifting part according to the disclosure;

FIG. 22 is a structural view of a hydraulic clamp part according to the disclosure;

FIG. 23 is a detailed front view of the hydraulic clamp part according to the disclosure;

FIG. 24 is an isometric view of the hydraulic clamp part according to the disclosure;

FIG. 25 is a structural view of a hydraulic claw according to the disclosure;

FIG. 26 is a structural view of a tower-wall concrete pouring system according to the disclosure;

FIG. 27 is an isometric view of a concrete pouring part according to the disclosure; and

FIG. 28 is a structural view of a concrete screw conveyor according to the disclosure.

### DESCRIPTION OF REFERENCE SIGNS

0000—building foundation part:
0001—underground level; 0002—basement level; 0003—ground level; 0004—building; 0005—prefabricated component;
1000—external frame part:
1001—first standard section; 1002—second standard section; 1003—third standard section; 1004—winch; 1005—first slide rail; 1006—first supporting rod;
2000—lifting platform part;
2001—Chinese character “Hui” lifting platform;
3000—transportation elevator part;
3001—fourth standard section; 3002—construction elevator; 3003—second supporting rod;
4000—three-layer enclosure part;
4001—three-layer Chinese character “Hui” enclosure baffle; 4002—access aisle; 4003—middle passageway; 4004—Chinese character “Hui” passageway; 4005—bottom supporting plate;
5000—top transfer part:
5001—second slide rail; 5002—mobile trolley; 5003—fifth standard section; 5004—lifting hook;
5005—auxiliary tower crane;
6000—carrying tower:
6100—tower standard section;
6101—tower standard section a, 6102—tower standard section b;
6200—hydraulic station a;
6201—oil storage tank, 6202—first motor, 6203—controller, 6204—hydraulic pump, 6205—solenoid valve group, 6206—servo valve;
6300—I-beam slideway;
6301—slide rail trolley, 6302—hinge support a, 6303—I-beam track a, 6304—I-beam track b;
7000—hammer—type pile driving system:
7100—connecting support;
7101—hinge support b, 7102—supporting steel plate, 7103—swingarm hydraulic cylinder a, 7104—swingarm hydraulic cylinder b, 7105—heavy-duty hinge support, 7106—U-shaped swingarm;
7200—multi-degree-of-freedom articulated arm;
7201—articulated arm oil cylinder hinge seat a, 7202—articulated arm oil cylinder a, 7203—first articulated arm, 7204—articulated arm oil cylinder hinge seat b, 7205—articulated arm oil cylinder b, 7206—second articulated arm, 7207—articulated arm oil cylinder c, 7208—arc-shaped link, 7209—straight link, 7210—steel plate;
7300—hammering part:
7301—hammer guide rod, 7302—steel frame, 7303—hammer, 7304—steel pile;
7310—hoisting mechanism;
7311—hydraulic motor a, 7312—reducer a, 7313—electromagnetic clutch, 7314—wire rope reel, 7315—reel fixing support, 7316—short I-beam a, 7317a—pulley a, 7317b—pulley b, 7317c—pulley c, 7318—short I-beam b, 7319—linear bearing;
7320—guide rod lifting mechanism;
7321—hydraulic motor b, 7322a—supporting plate a, 7322b—supporting plate b, 7323a—tension spring a, 7323b—tension spring b, 7323c—tension spring c, 7323d—tension spring d, 7324a—deep groove pulley a, 7324b—deep groove pulley b, 7325—hollowed supporting plate, 7326a—square slide rail a, 7326b—square slide rail b, 7327a—slider a, 7327b—slider b;
7400—hydraulic pile clamping part:
7401—hydraulic clamp base, 7402—hydraulic clamp oil cylinder hinge support, 7403—hydraulic clamp oil cylinder, 7405a—curved steel jaw a, 7405b—curved steel jaw b;
7410—centering clamping mechanism;
7411a—slide rod support a, 7411b—slide rod support b, 7411c—slide rod support c, 7411d—slide rod support d, 7412a—rod—type slider a, 7412b—rod—type slider b, 7413a—slide rod a, 7413b—slide rod b, 7413c—slide rod c, 7413d—slide rod d, 7414—gear fixing support, 7415—gear, 7416a—rack a, 7416b—rack b, 7417a—rack guide support a, 7417b—rack guide support b, 7418—anti—collision rod;
8000—hydraulic claw:
8001—hydraulic claw base, 8002—hydraulic cylinder a, 8003—arc—shaped steel jaw;
9000—tower-wall concrete pouring system:
9001—fixed bottom plate, 9002—hinge support c, 9003—hydraulic station b;
9010—concrete pouring part;
9011—four-legged base, 9012—hydraulic turntable, 9013—counterweight, 9014—concrete pump, 9015—concrete conveying duct, 9016—articulated boom, 9017—hydraulic cylinder b;
9100—concrete screw conveyor;
9101—second motor, 9102—motor reducer, 9103—belt drive mechanism, 9104—screw shaft, 9105—concrete bin, 9106—ground conveying duct, 9107—concrete discharge port.

### DETAILED DESCRIPTION OF THE EMBODIMENTS

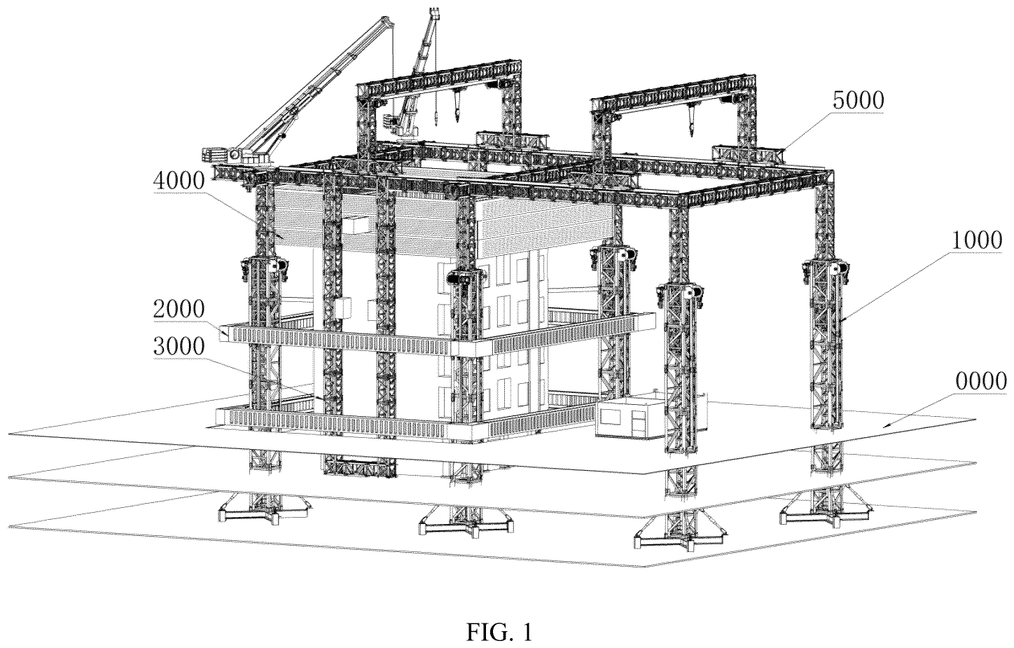

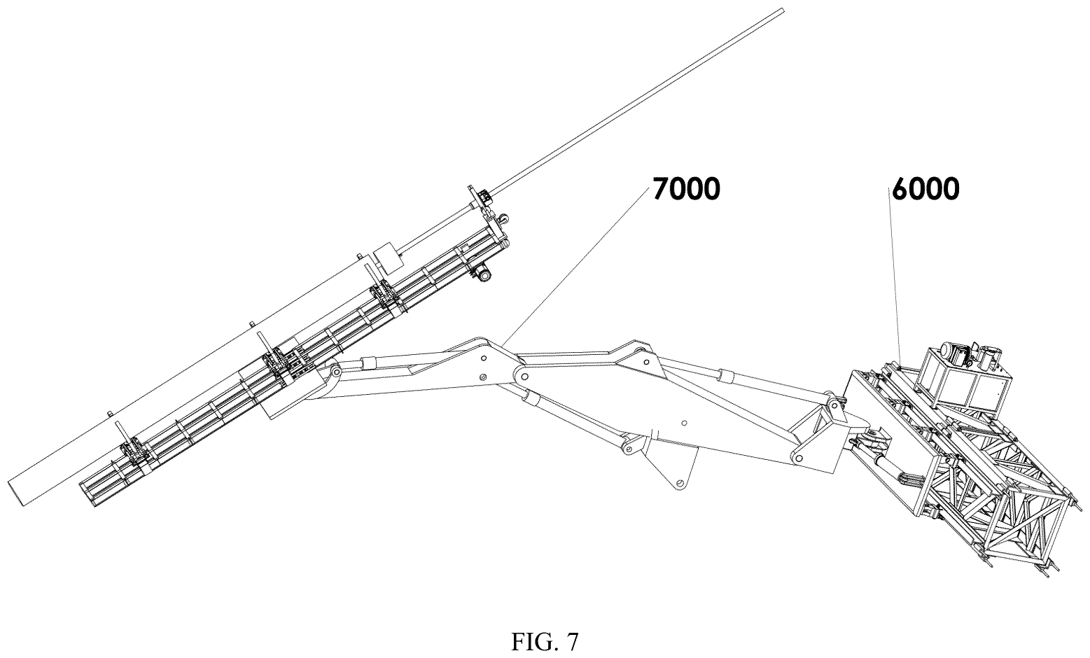

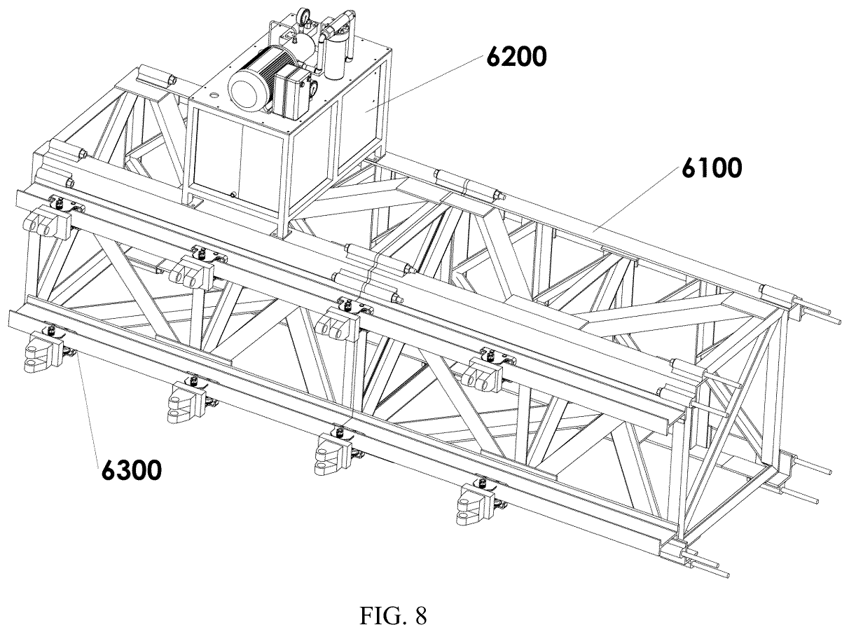

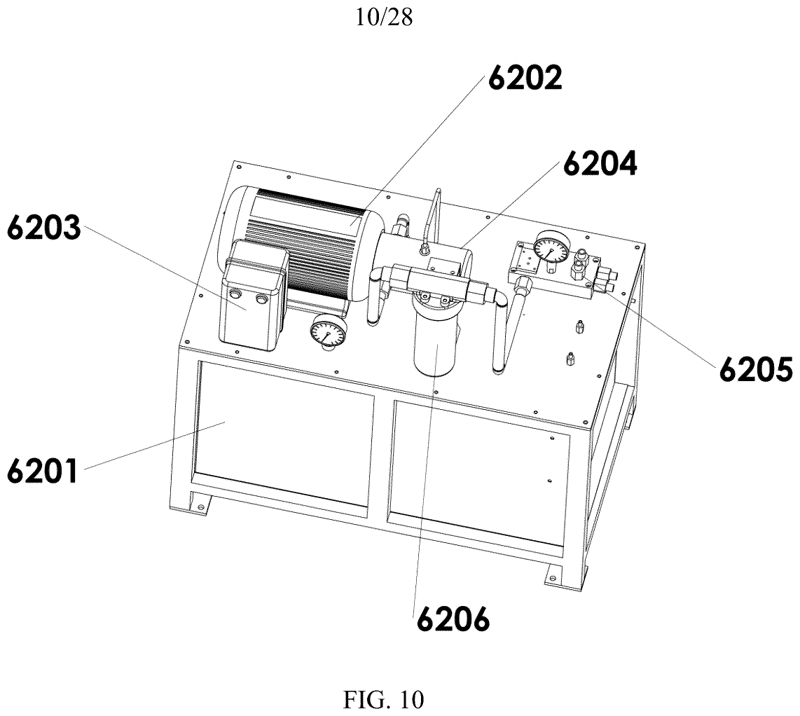

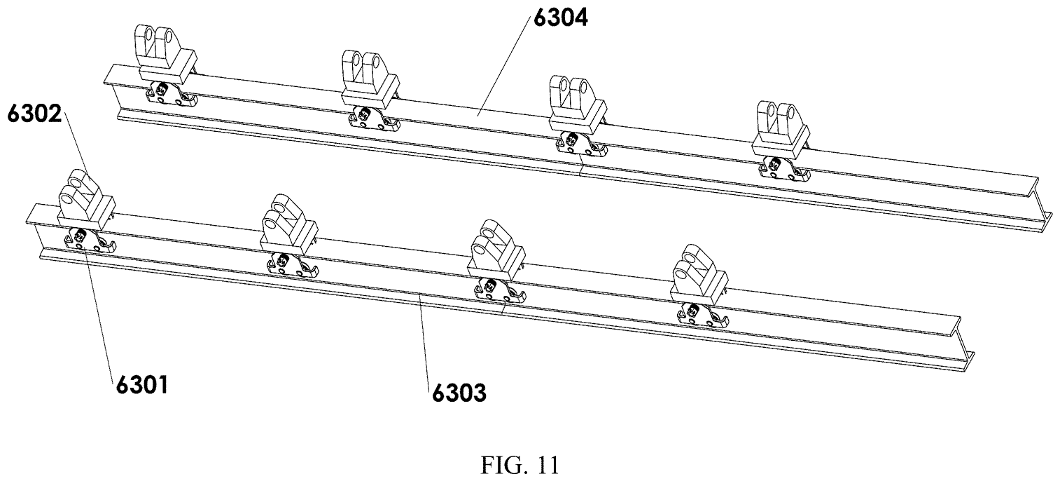

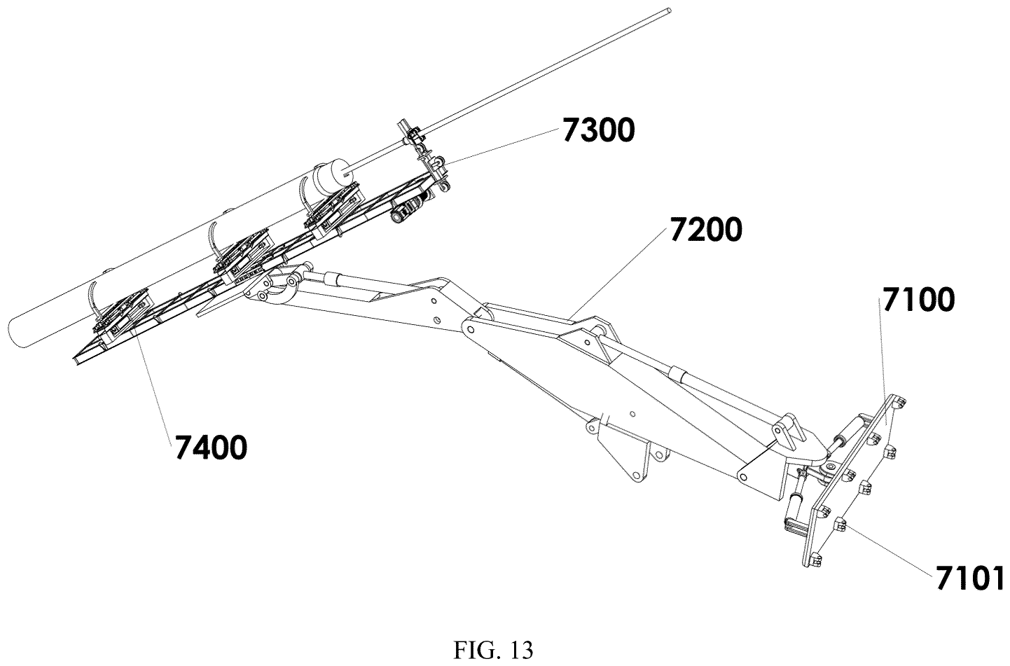

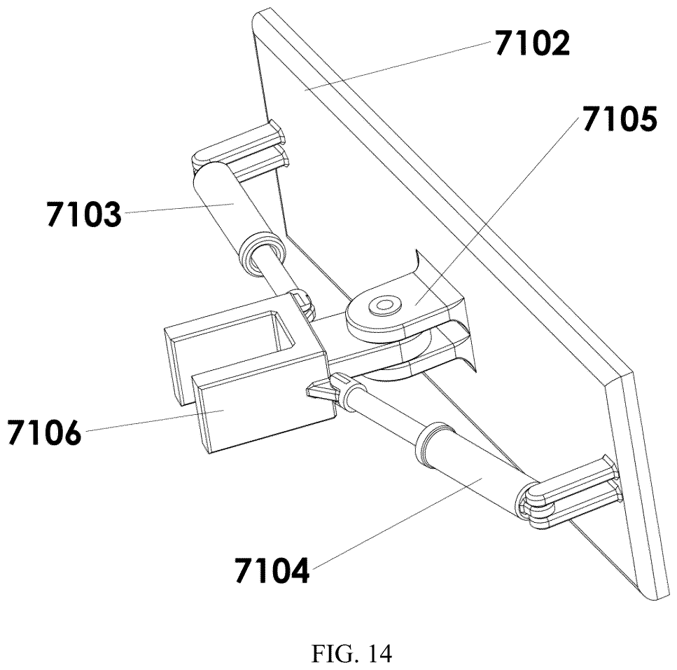

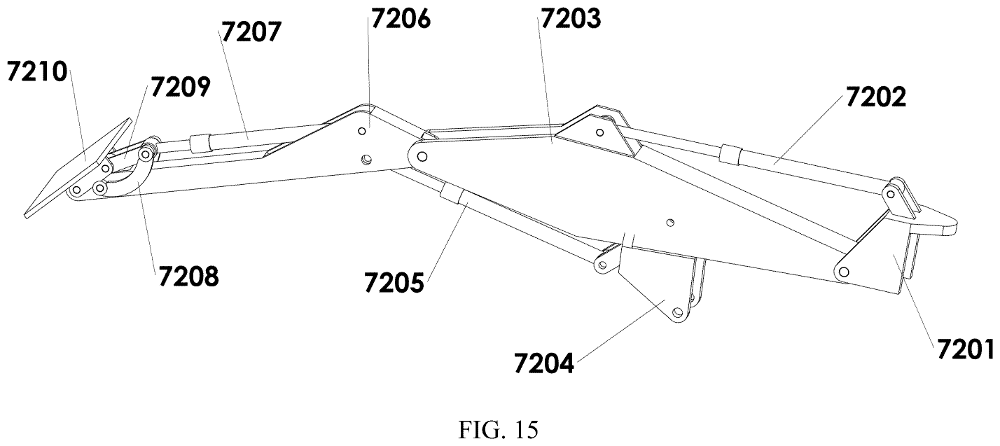

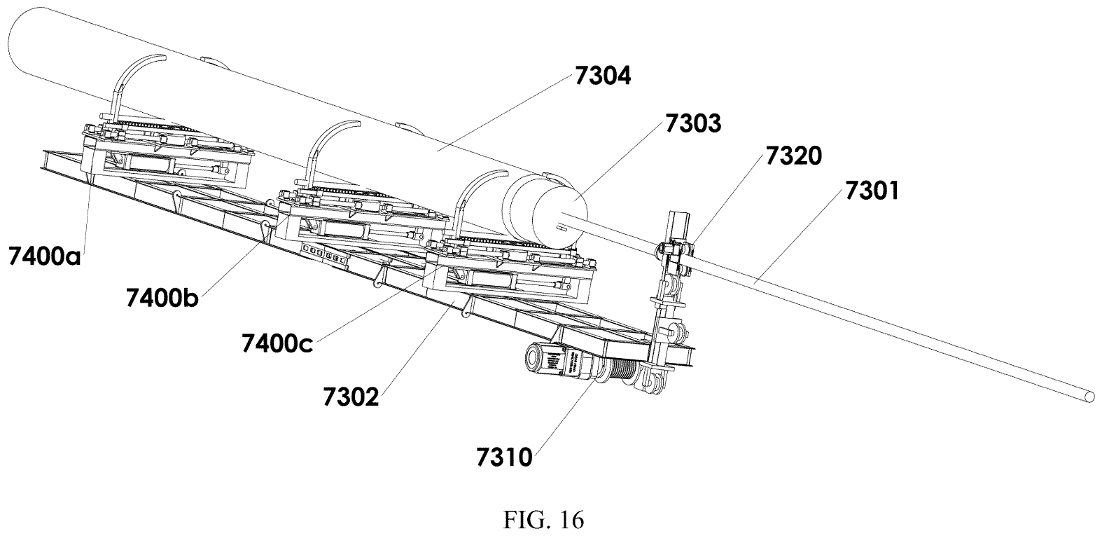

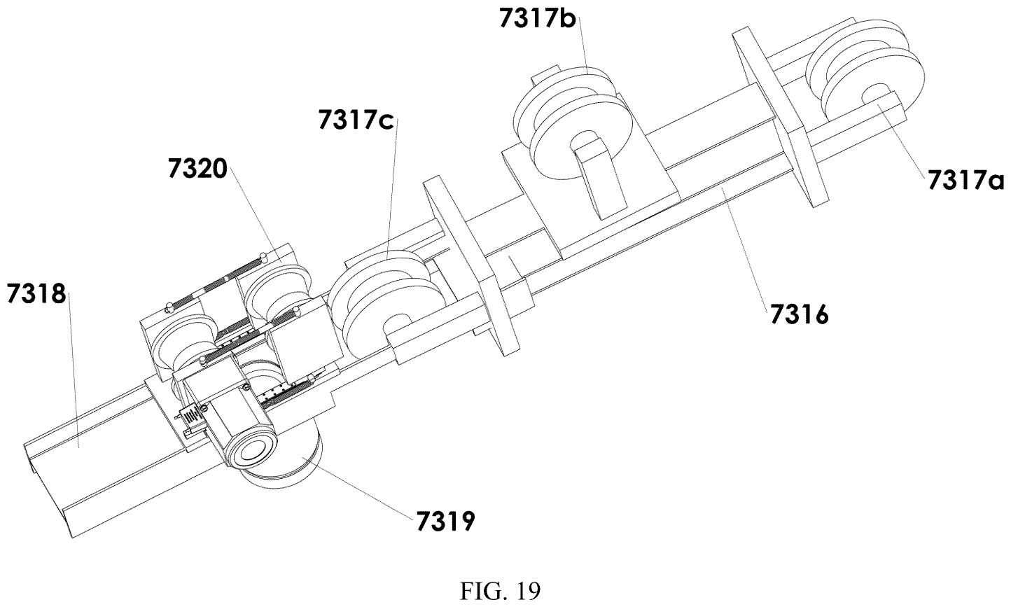

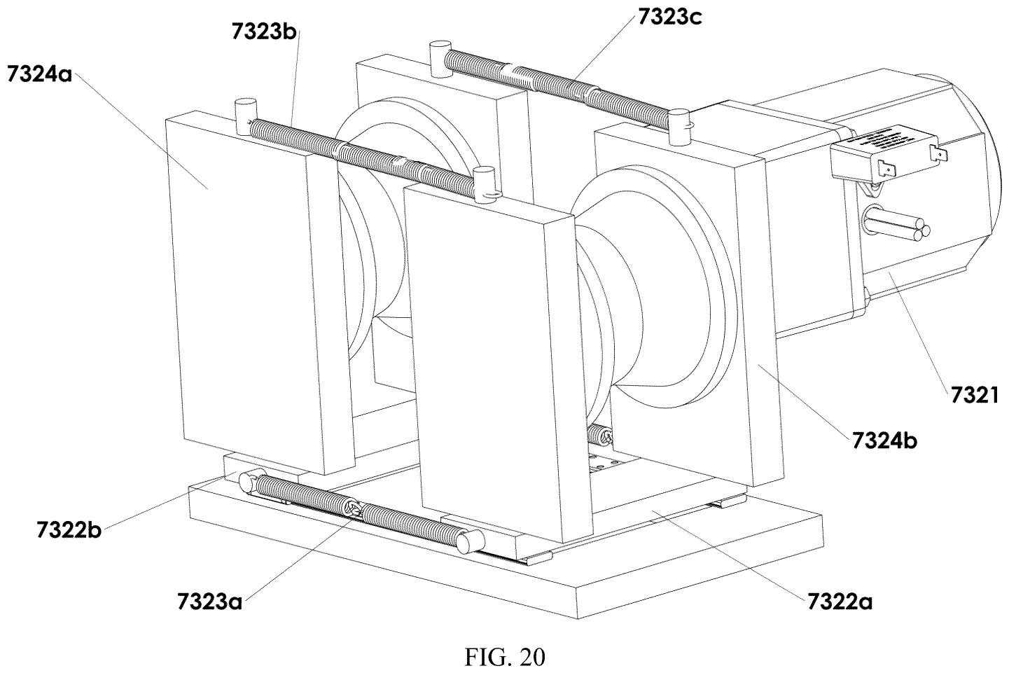

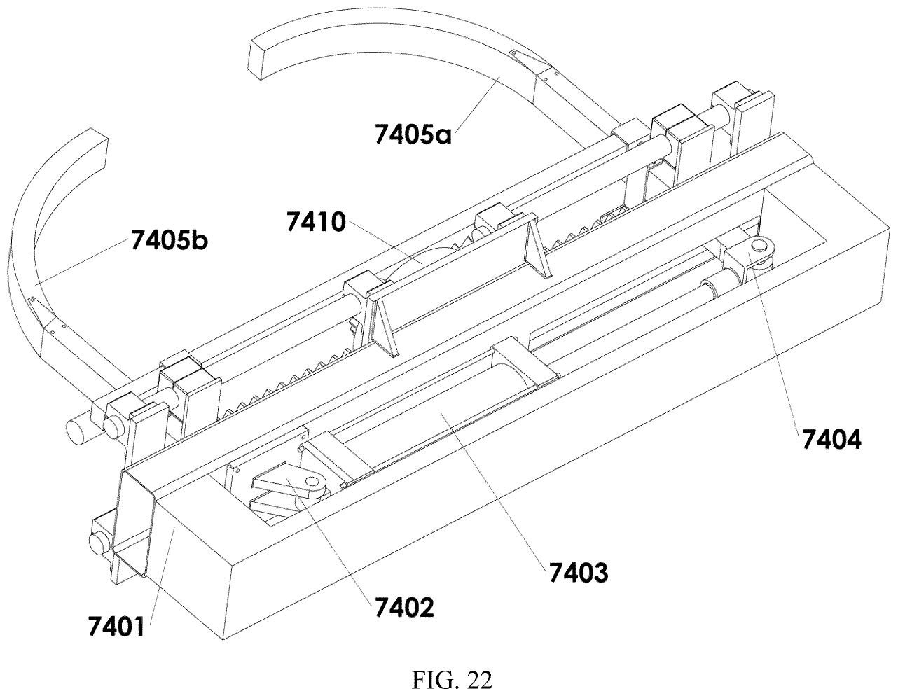

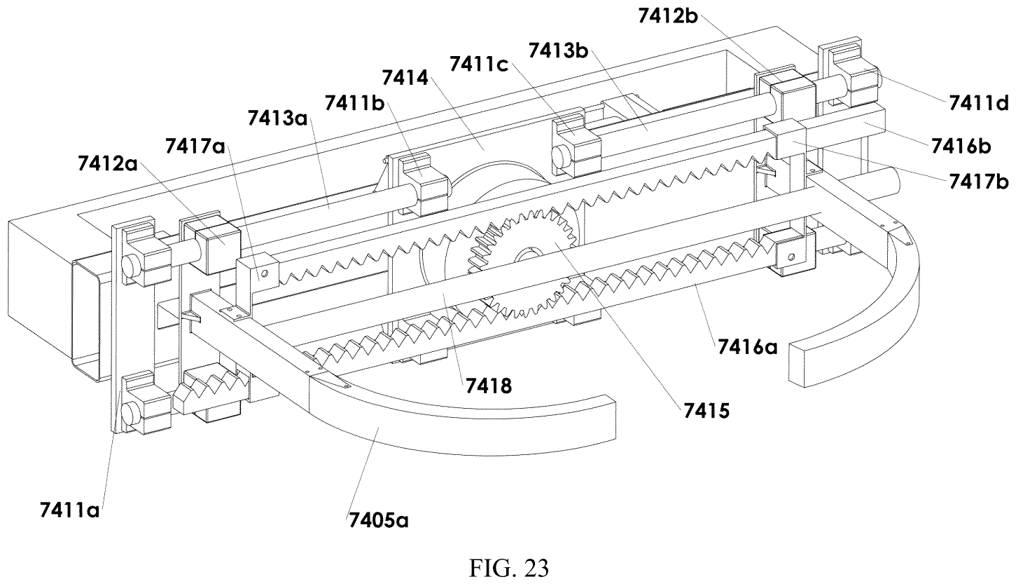

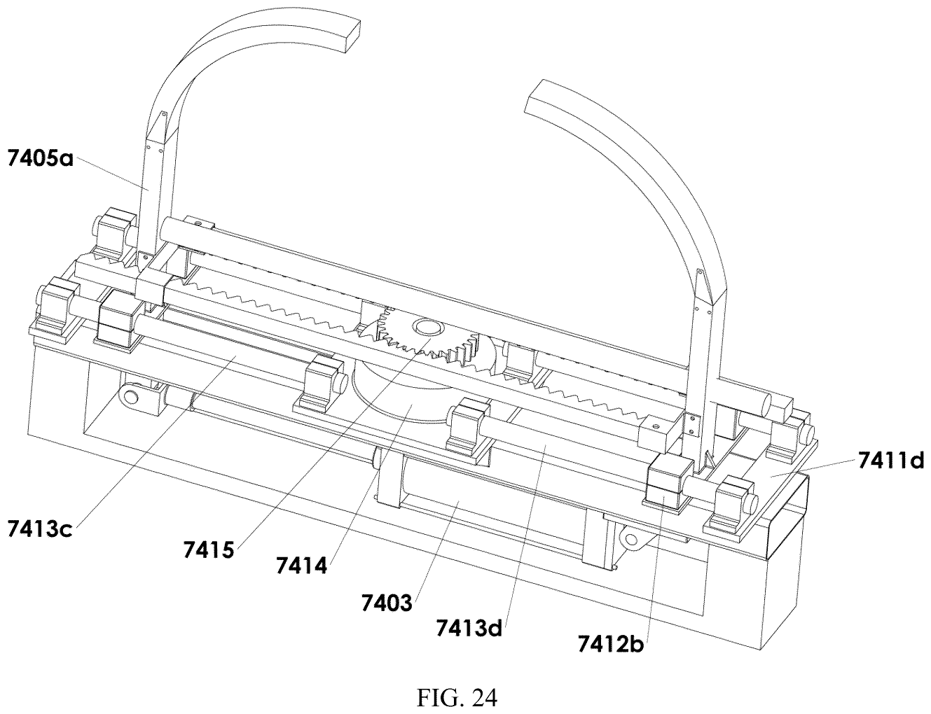

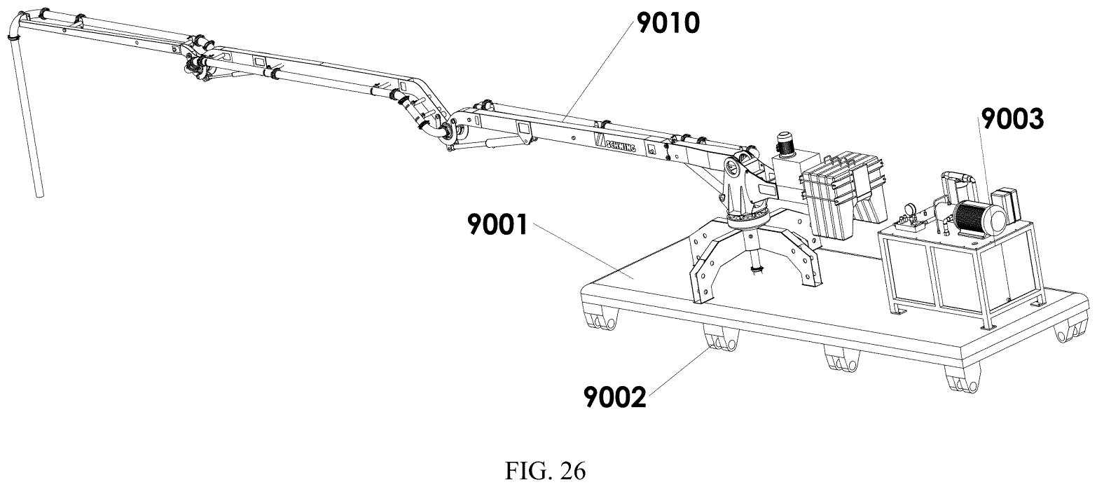

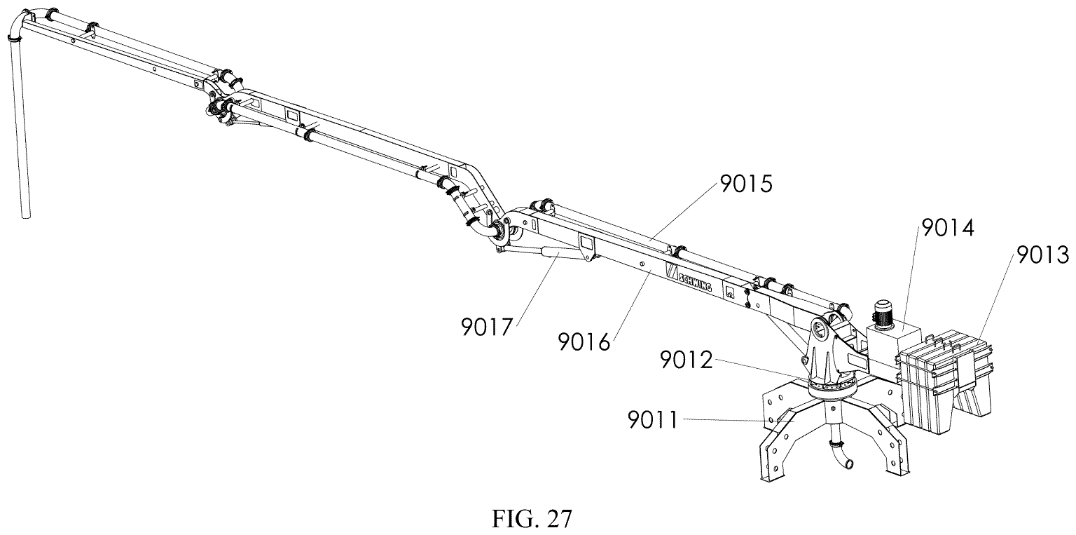

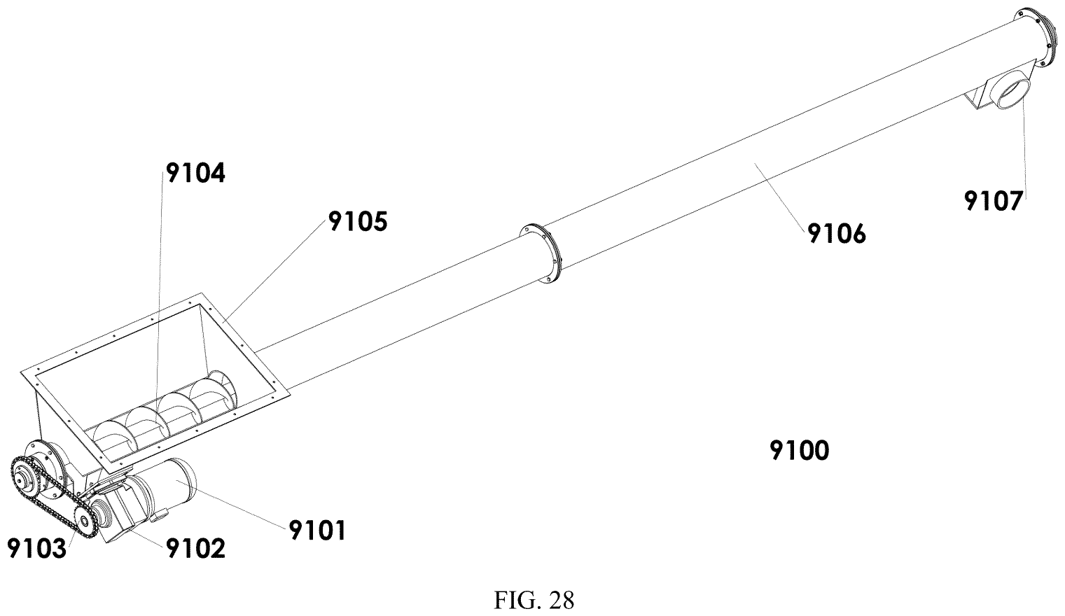

An expandable multifunctional integrated-construction skyscraper building platform and a construction method using the same provided by the disclosure will be described in detail below with reference to FIG. 1 to FIG. 28.

As shown in FIG. 1, the expandable multifunctional integrated-construction skyscraper building platform of the disclosure mainly includes a building foundation part 0000, an external frame part 1000, lifting platform parts 2000, a transportation elevator part 3000, a three-layer enclosure part 4000, a top transfer part 5000, a carrying tower 6000, a hammer-type pile driving system 7000, hydraulic claws 8000 and a tower-wall concrete pouring system 9000. The building foundation part 0000 serves as a bottom support for the whole platform. The external frame part 1000 and the transportation elevator part 3000 are mounted on the building foundation part 0000. The three-layer enclosure part 4000, the top transfer part 5000 and the carrying tower 6000 are mounted on the external frame part 1000. The carrying tower 6000 is configured to carry and fix the hammer-type pile driving system 7000 and the tower-wall concrete pouring system 9000.

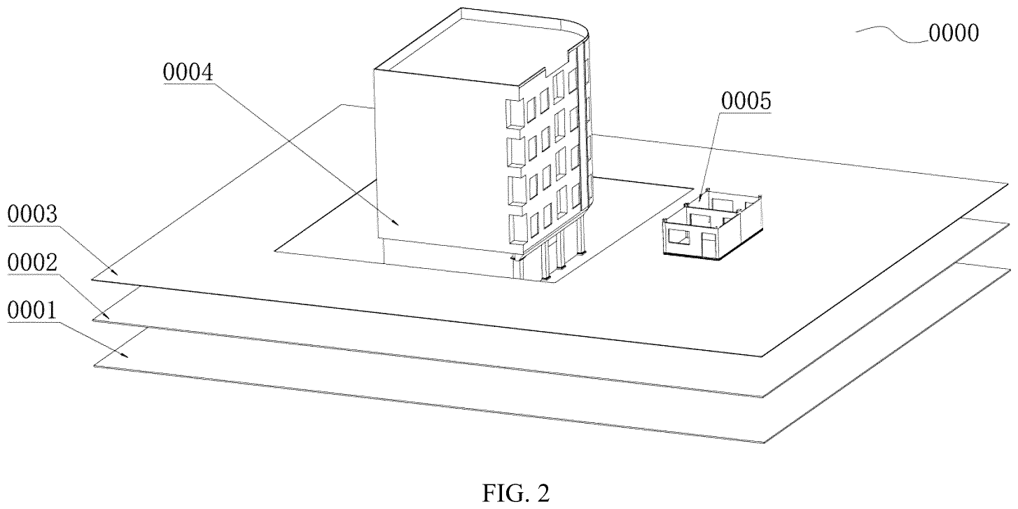

As shown in FIG. 2, the building foundation part 0000 includes an underground level 0001, a basement level 0002 and a ground level 0003 which form a main body. A building 0004 is located on top of the basement level 0002, and a prefabricated component 0005 is located on top of the ground level 0003 and in front of the building 0004. Compared with the prior art, the bottom of the external frame part 1000 in the disclosure is fixed deep into the underground level 0001, and the top of the external frame part runs through the basement level 0002 and the ground level 0003 to reach upper air such that the lifting platform parts 2000 arranged on the external frame part 1000 are capable of going up from the underground level for construction. Since the building 0004 is located on top of the basement level 0002, the whole building can be constructed upward from the underground level, thereby effectively widening the construction range. Moreover, since the lifting platform parts 2000 can reach the ground level 0003 and the basement level 0002, the construction robots can enter the lifting platform parts 2000 more conveniently, which can be lifted for construction operation.

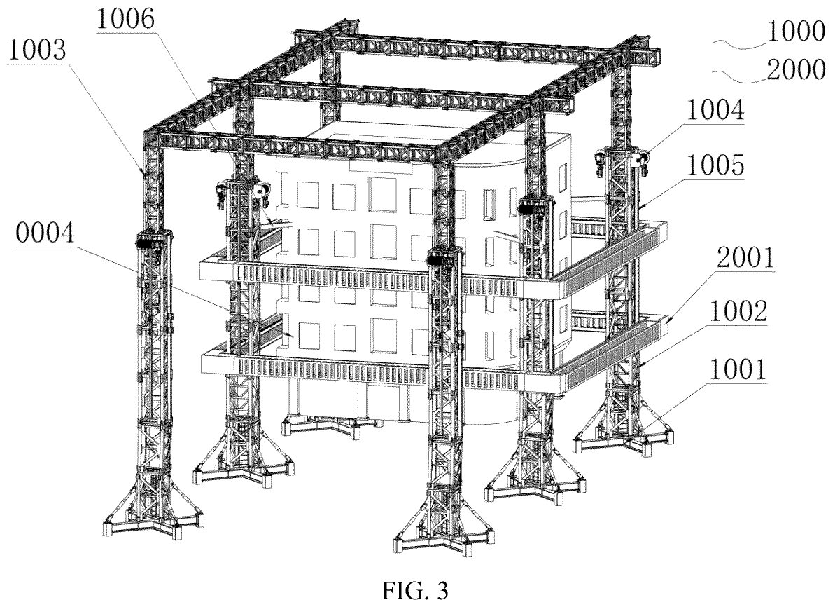

As shown in FIG. 3, the external frame part 1000 includes six first standard sections 1001 which form a bottom support and are mounted on the underground level 0001, and a plurality of second standard sections 1002 are mounted on the six first standard sections. A construction area formed by the six vertical standard sections (first standard sections 1001) is divided into a building construction area and a material conveying area, respectively formed by every four adjacent first standard sections. Relative ranges of the areas can be changed according to needs. A vertical standard section column formed by a plurality of third standard sections 1003 runs through a middle of a top of the second standard section 1002, and is movable up and down through an actuator such as an oil cylinder. Tops of every two vertical standard section columns are connected through horizontal third standard sections to form a Chinese character “Ri” frame. Vertical columns formed by the second standard sections 1002 are each provided with a first slide rail 1005 on an outer side, a winch 1004 on a top and a first supporting rod 1006 on an inner side. The first slide rails 1005 are provided with the two lifting platform parts 2000 which are pullable by the winches 1004 to realize height adjustment on the first slide rails 1005. The other end of the first supporting rod 1006 is fixed to a surface of the building such that the whole external frame part 1000 is attached to the building 0004.

The lifting platform part 2000 includes a Chinese character “Hui” lifting platform 2001 which forms the main body. The shape of the Chinese character “Hui” lifting platform 2001 can be designed in advance according to the actual shape of the building, so that the tracks are always closely attached to the surface of the building and the construction robots on the lifting platform can perform construction smoothly on the surface of the building. Compared with the structure simply attached to a periphery of the building in the prior art, standard section combinations and supporting rods are designed on the periphery of the building in the disclosure, so that the external frame part 1000 of the lifting platform is effectively attached to the building. With the slidable lifting platform parts 2000 on the standard sections, the construction robots can perform effective construction while being closely attached to the building, thereby improving the efficiency. Moreover, in the disclosure, the two-standard-section combination arranged on the outer side of the original four-standard-section combination forms a Chinese character “Ri” expanded combination, so that the frame part can not only be attached to the surface of the building, but also obtain a huge external expanded space which can be used for storing prefabricated components 0005, construction materials, construction waste and the like, thereby effectively increasing the space utilization. Besides, this external space for storage can greatly reduce the material transportation and handling cost. It should be noted that this example only shows the expanded space on one side, but there may be expanded spaces on the front and rear sides according to actual conditions so as to further increase the space. In this case, the expanded space on one side is used for conveying construction materials, and the expanded space on the other side is used for transporting construction waste out, thereby realizing a closed loop of the whole building and improving the efficiency.

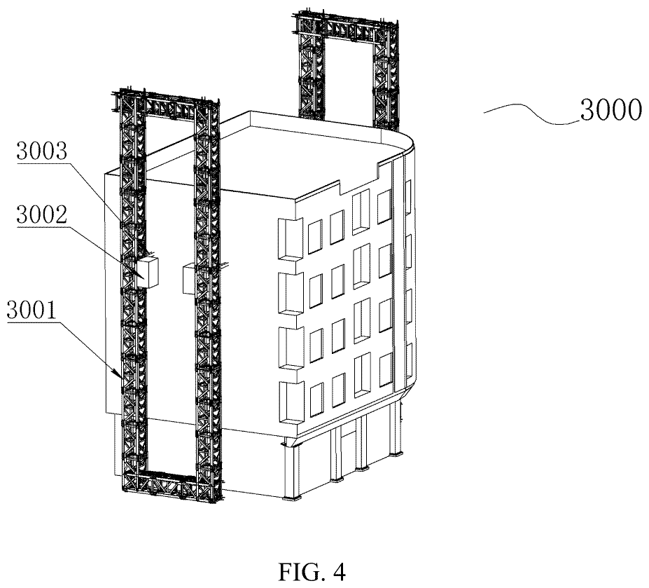

As shown in FIG. 4, the transportation elevator part 3000 includes a vertical rectangular frame which is formed by fourth standard sections 3001 and forms a main body. Two construction elevators 3002 are arranged inside two vertical sides of the vertical rectangular frame and movable on tracks formed by the fourth standard sections 3001 so as to transport workers, robots and construction materials to higher floors. Inner sides of the fourth standard sections 3001 are provided with second supporting rods 3003 connected to the building 0004, which makes the whole frame more stable. The horizontal standard section on the top of the vertical rectangular frame is actually the horizontal third standard section 1003 of the external frame part 1000, and the horizontal standard section on the bottom of the vertical rectangular frame is mounted on top of the basement level 0002. That is, a top of the transportation elevator part 3000 is connected to the external frame part 1000, a bottom is on the same bottom surface as the building 0004, and the rectangular standard section combination (vertical rectangular frame) surrounds an access aisle 4002 of the three-layer enclosure part 4000, so that the construction elevators 3002 are capable of reaching a height of the access aisle 4002. Compared with the prior art, with the fourth standard section 3001 combination designed in the disclosure, the construction elevators 3002 can move between the building foundation part 0000 and the three-layer enclosure part 4000, so that the construction robots, the construction workers and the construction materials can be efficiently transported to higher floors from the inside, thereby improving the transportation efficiency. Moreover, the construction elevators can be used as discharge ports to quickly transport the construction waste from high places to the outside.

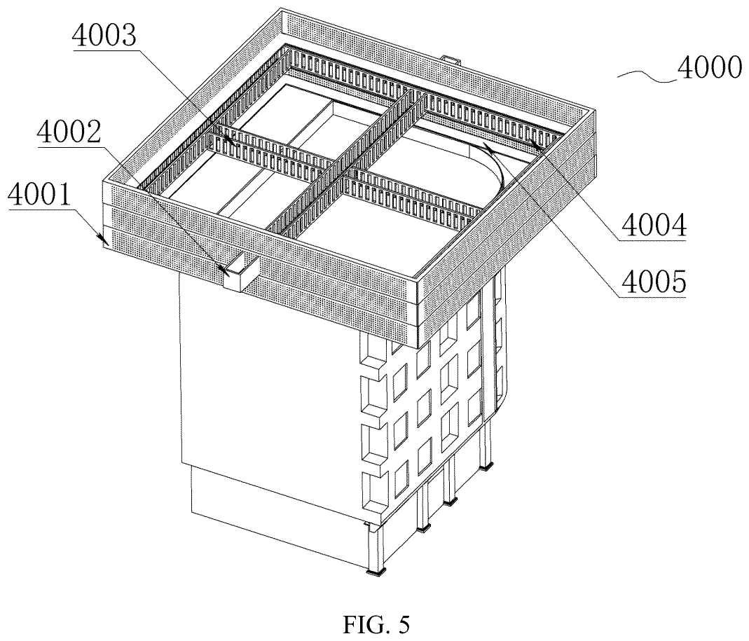

As shown in FIG. 5, the three-layer enclosure part 4000 includes a three-layer Chinese character “Hui” enclosure baffle 4001 which forms a main body. An outside of the baffle is mounted on inner sides of the four vertical third standard sections 1003 of the external frame part 1000, and the baffle is movable up and down along the third standard sections 1003 through actuators such as oil cylinders. An inner side of the three-layer Chinese character “Hui” enclosure baffle 4001 is provided with a Chinese character “Hui” bottom supporting plate 4005, and a Chinese character “Hui” passageway 4004 is mounted on top of the bottom supporting plate 4005. Only one Chinese character “Hui” passageway is shown in the figure, but actually, there are three passageways. Middle passageways 4003 and access aisles 4002 are arranged in a middle of the Chinese character “Hui” passageway 4004. It should be noted that a middle cross passageway formed by the middle passageways 4003 and the access aisles 4002 are capable of being installed or removed in advance. For example, when the whole three-layer enclosure part 4000 moves to above a top of the building 0004, the middle cross passageway is capable of being installed, and when the whole three-layer enclosure part moves to below the top of the building, the middle cross passageway is capable of being removed, so that the three-layer enclosure part 4000 is capable of enclosing the whole building 0004 for maintenance. The three-layer Chinese character “Hui” enclosure baffle 4001 here sequentially acts as an operation layer, a maintenance layer and an enclosure layer from top to bottom. Compared with manual enclosure in the prior art which is time-consuming and labor-intensive, in the disclosure, through the cooperation between the three-layer enclosure structure combination and the passageways inside, the construction robots and the construction materials can be directly transported from the bottom into the access aisle 4002 through the transportation elevator part 3000 and further enter the Chinese character “Hui” passageway 4004 inside the three-layer Chinese character “Hui” enclosure baffle 4001 so as to construct the building, thereby improving the material transportation and construction efficiency. Thus, this platform can perform structured construction from top to bottom, i.e., performing operation at the top, maintenance in the middle and enclosure at the bottom. After the operation at the top is completed, the whole platform can be moved up, so that the maintenance can be performed in the middle. After a specified time, the maintenance is completed, and then the platform is moved up, such that the enclosure is performed at the bottom layer. In this way, the time utilization is maximized, the efficiency is improved, and the cost is reduced.

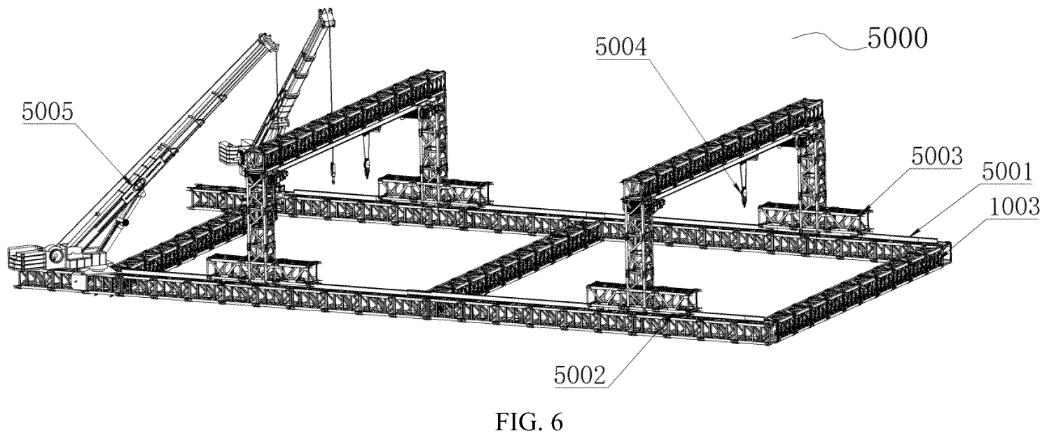

As shown in FIG. 6, the top transfer part 5000 is mounted on the Chinese character “Ri” frame at a top of the external frame part 1000. Left and right tracks of the Chinese character “Ri” frame are provided with second slide rails 5001. Mobile trolleys 5002 are arranged on the second slide rails 5001. Gantry crane structures (lifting devices) formed by a plurality of fifth standard sections 5003 are arranged on the mobile trolleys 5002. The lifting devices can realize lifting through lifting hooks 5004 thereon. The two lifting devices are respectively located in two square areas of the Chinese character “Ri” frame and can work together for lifting. The top transfer part 5000 further includes two auxiliary tower cranes 5005 mounted at tails ends of the second slide rails 5001 and located at a side of the building. Compared with the traditional tower crane, the two gantry crane structures on the top in the disclosure can lift heavy objects easily and more stably. Since the building construction area and the material conveying area are provided in the disclosure, the two gantry crane structures can transport the construction materials from the ground level to the top of the high-rise building quickly and efficiently. Since the gantry crane structures can lift the heavy objects, PC prefabricated components such as prefabricated rooms can be lifted directly, which can greatly improve the construction efficiency. Moreover, there are two auxiliary tower cranes 5005 that can lift light materials to the top of the building. Through the combination of expanded external transportation and internal transportation, the efficient cooperation between machinery and humans can be realized, thereby improving the overall conveying efficiency.

The carrying tower 6000, the hammer-type pile driving system 7000, the hydraulic claws 8000 and the tower-wall concrete pouring system 9000 are all function modules of the lifting platform. The carrying tower 6000 is mainly configured to carry and fix the hammer-type pile driving system 7000 and the tower-wall concrete pouring system 9000. The hammer-type pile driving system 7000, which is a hydraulic pile driving system, is mainly configured to clamp a steel pile, move the steel pile to the preset position and hammer the steel pile into the earth by means of a hammering part. The tower-wall concrete pouring system 9000 is mounted on tower standard sections 6100 and is capable of pumping concrete on the ground level to a construction area covered by the tower so as to perform pouring in place of a traditional pump truck. The hydraulic claw 8000, which is a mobile tower crane transportation claw, can be mounted on the lifting hook 5004 of the lifting platform, and can be driven by the hydraulic station to complete earth excavation and transportation in the construction area. The principles of the structures involved above and the connection relationship of parts will be described in detail below.

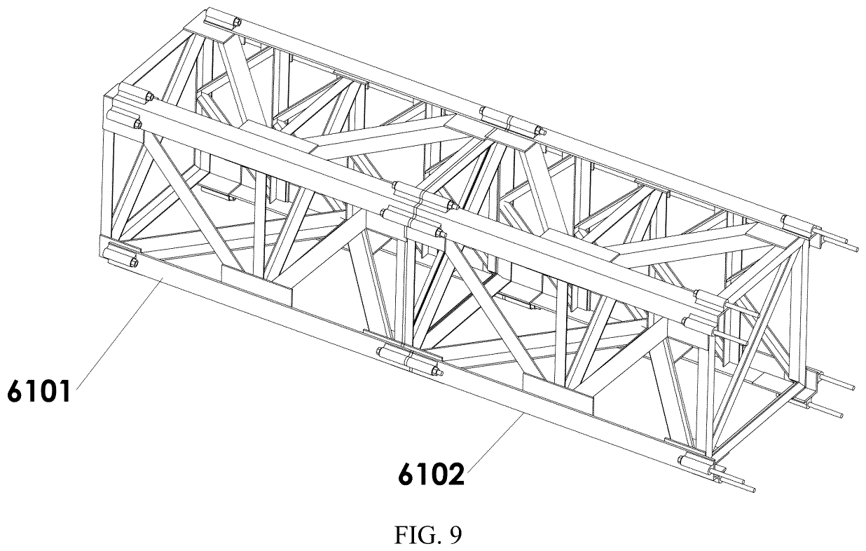

The carrying tower 6000 includes tower standard sections 6100, a hydraulic station a 6200 and an I-beam slideway 6300. The tower standard sections 6100 have a structure as shown in FIG. 9, and are formed by welding steel frames. Tower standard sections a 6101 and tower standard sections b 6102 having the same structure may be connected through bolts to form a combination having a length according to the construction area covered by the tower. The combination of the tower standard sections 6100 is fixed in the same way as a lifting cross beam on top of the top transfer part 5000. The carrying tower 6000 forms a biaxial mobile platform, and the winches drive the slide rail trolleys 6301 to move, so that the hammer-type pile driving system 7000 can move freely in a plane parallel to the ground level and perform pile driving at every position in the construction area.

The hydraulic station a 6200 provides power for oil cylinders of the hammer-type pile driving system 7000 and drives elements to complete corresponding actions. The hydraulic station a 6200 includes an oil storage tank 6201, a first motor 6202, a controller 6203, a hydraulic pump 6204, a solenoid valve group 6205 and a servo valve 6206. The connection relationship between the elements is as follows: The oil storage tank 6201 is a hydraulic oil storage unit that provides hydraulic oil for the device. The first motor 6202 is connected to a tower crane through a wire and powered by the tower crane to drive the hydraulic pump 6204 to generate high-pressure hydraulic oil, and the servo valve 6202 adjusts a pressure and a flow of the high-pressure hydraulic oil, thereby controlling extension and retraction speeds of the oil cylinders of the hammer-type pile driving system 7000 and controlling action speeds of the multi-degree-of-freedom articulated arm 7200 and the hammering part 7300. The solenoid valve group 6205 includes a plurality of solenoid valves and is configured to distribute flow directions of the hydraulic oil and control oil paths to be connected or disconnected, thereby controlling the actions of the oil cylinders of the hammer-type pile driving system 7000. By means of remote control, the controller 6203 can remotely control the servo valve 6206 and the solenoid valve group 6205 to be on or off, and the workers can remotely control the hammer-type pile driving system 7000 to move and perform pile driving on the ground level.

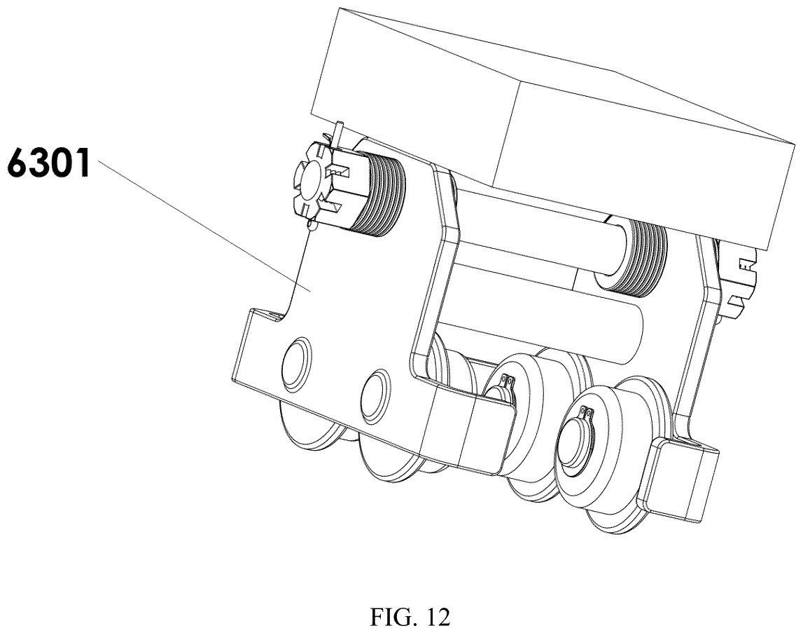

The I-beam slideway 6300 includes slide rail trolleys 6301, hinge supports a 6302, an I-beam track a 6303 and an I-beam track b 6304. The I-beam track a 6303 and the I-beam track b 6304 are steel tracks, which are fixed to a side surface of the tower standard sections 6100 by welding and have the same length as the tower standard sections. When the tower standard sections 6100 are combined and connected, different I-beam tracks are in close contact with each other to form a long I-beam track. The slide rail trolley 6301 has a structure as shown in FIG. 12, includes a steel roller wheel, a base, a limiting roller, etc., and can cooperate with the I-beam track a 6303 and the I-beam track b 6304 to slide freely along the track. The plurality of slide rail trolleys 6301 are mounted on the I-beam tracks. A base of the hinge support a 6302 is fixedly connected to a base of the slide rail trolley 6301 through bolts. Pin holes of the hinge supports a 6302 on the I-beam track a 6303 and the I-beam track b 6304 face different directions, and have axes perpendicular to each other, thereby ensuring a holonomic constraint after being connected to the hinge supports b 7101 through hinge pins. The hammer-type pile driving system 7000 is mounted or removed by means of lifting by a crane. The connection through hinge pins provides convenience for quick mounting and removal.

The hammer-type pile driving system 7000 is configured to clamp, move and hammer a steel pile, and includes a connecting support 7100, the multi-degree-of-freedom articulated arm 7200, the hammering part 7300 and hydraulic pile clamping parts 7400. The connecting support 7100 is configured to support and fix the multi-degree-of-freedom articulated arm 7200 to ensure stable movement of the hammer-type pile driving system 7000. The multi-degree-of-freedom articulated arm 7200 has a same structure as an articulated arm of an excavator, and drives articulated arms to complete corresponding actions through hydraulic cylinders. The hammering part 7300 lifts a hammer through a hydraulic winch and releases the hammer to hammer the steel pile, and the hammer repeatedly hammers the steel pile, thereby completing a pile driving process. The plurality of hydraulic pile clamping parts 7400 work at the same time, and a hydraulic cylinder drives a clamping mechanism to clamp the steel pile and controls the multi-degree-of-freedom articulated arm 7200 to move the steel pile, adjust an orientation of the steel pile and stably insert the steel pile 7304 into a foundation pit. It takes a short time for the hammer to hammer the steel pile, thereby reducing a clamping force of the hydraulic cylinder of the hydraulic pile clamping part 7400 and ensuring the steel pile 7304 to be smoothly hammered into the earth. The connection relationship between the above elements and the principles will be described in detail below.

The connecting support 7100 includes hinge supports b 7101, a supporting steel plate 7102, a swingarm hydraulic cylinder a 7103, a swingarm hydraulic cylinder b 7104, a heavy-duty hinge support 7105 and a U-shaped swingarm 7106. The supporting steel plate 7102 is used as a basic base of the hammer-type pile driving system 7000, the hinge supports b 7101 are fixed to a back side of the supporting steel plate 7102, and pin holes of the two rows of the hinge supports b 7101 have axes perpendicular to each other and are connected to the hinge supports a 6302 through hinge pins, thereby achieving a holonomic constraint. The heavy-duty hinge support 7105 is welded and fixed to a middle position of a front side of the supporting steel plate 7102 and is capable of carrying a weight of the whole hammer-type pile driving system 7000. A pin hole at one end of the U-shaped swingarm 7106 is connected to the heavy-duty hinge support 7105 through a hinge pin, and two sides of the U-shaped swingarm are provided with small pin holes respectively hinged with retractable ends of the swingarm hydraulic cylinder a 7103 and the swingarm hydraulic cylinder b 7104. Cylinder tails of the swingarm hydraulic cylinder a 7103 and the swingarm hydraulic cylinder b 7104 are connected to pin hole seats fixed to two sides of the supporting steel plate 7102 through hinge pins, and thereby, the U-shaped swingarm 7106 is controlled by the swingarm hydraulic cylinder a 7103 and the swingarm hydraulic cylinder b 7104 to rotate around an axis of a pin hole of the heavy-duty hinge support 7105 such that the multi-degree-of-freedom articulated arm 7200 rotates left and right, thereby improving the flexibility.

The multi-degree-of-freedom articulated arm 7200 includes an articulated arm oil cylinder hinge seat a 7201, an articulated arm oil cylinder a 7202, a first articulated arm 7203, an articulated arm oil cylinder hinge seat b 7204, an articulated arm oil cylinder b 7205, a second articulated arm 7206, an articulated arm oil cylinder c 7207, an arc-shaped link 7208, a straight link 7209 and a steel plate 7210. The articulated arm oil cylinder hinge seat a 7201 is welded and fixed to an upper part of the U-shaped swingarm 7106, the articulated arm oil cylinder hinge seat 7201 a is rotatable along with the U-shaped swingarm 7106, a pin hole at one end of the first articulated arm 7203 is hinged with a pin hole at a lower part of the articulated arm oil cylinder hinge seat a 7201 through a hinge pin, a pin hole at the other end is hinged with a pin hole of the second articulated arm 7206 through a hinge pin, and a pin hole at an upper part of the first articulated arm is hinged with a retractable end of the articulated arm oil cylinder a 7202 through a hinge pin. A cylinder tail of the articulated arm oil cylinder a 7202 is hinged with a pin hole at an upper part of the articulated arm oil cylinder hinge seat a 7201 through a hinge pin, and extension and retraction of the articulated arm oil cylinder a 7202 can control a lifting action of the first articulated arm 7203. The articulated arm oil cylinder hinge seat b 7204 is welded and fixed below the first articulated arm 7203, a cylinder tail of the articulated arm oil cylinder b 7205 is hinged with a pin hole at an end portion of the articulated arm oil cylinder hinge seat b 7204 through a hinge pin, a retractable end of the articulated arm oil cylinder b is hinged with a pin hole at a lower part of the second articulated arm 7206 through a hinge pin, and extension and retraction of the articulated arm oil cylinder b 7205 can control a lifting action of the second articulated arm 7206. A pin hole at an upper part of the second articulated arm 7206 is hinged with a cylinder tail of the articulated arm oil cylinder c 7207 through a hinge pin, a retractable end of the articulated arm oil cylinder c 7207 is hinged with a pin hole at one end of the arc-shaped link 7208 and a pin hole at one end of the straight link 7209 through a hinge pin, another pin hole of the arc-shaped link 7208 is hinged with a pin hole of the second articulated arm 7206 close to the other end through a hinge pin, another pin hole of the straight link 7209 is hinged with a pin hole at an upper part of the steel plate 7210 through a hinge pin, and extension and retraction of the articulated arm oil cylinder c 7207 can control a pitching action of the steel plate 7210. The articulated arm oil cylinder a 7202, the articulated arm oil cylinder b 7205 and the articulated arm oil cylinder c 7207 take the hydraulic station a 6200 as a power source, and cooperate with each other to realize flexible actions of the multi-degree-of-freedom articulated arm 7200.

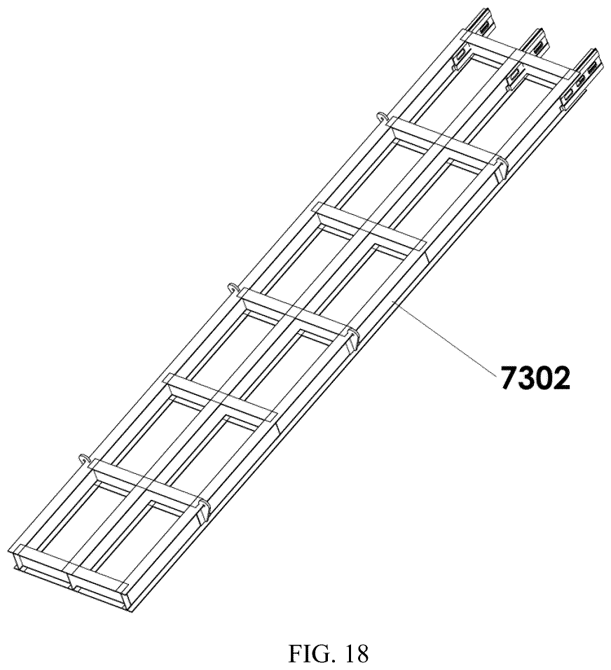

The hammering part 7300 includes a hammer guide rod 7301, a steel frame 7302, a hammer 7303, the steel pile 7304, a hoisting mechanism 7310 and a guide rod lifting mechanism 7320. The steel frame 7302 has a structure as shown in FIG. 18, and is formed by welding a plurality of I-beams and used as a fixed base of the hammer-type pile driving system 7000. The hammer guide rod 7301 is an alloy long rod running through the guide rod lifting mechanism 7320 which controls a lifting height of the hammer guide rod. The hammer 7303 is a steel cylinder with a circular hole at a center, two ends of the circular hole are provided with linear bearings, the hammer guide rod 7301 runs through the circular hole, the hammer is slidable up and down along the hammer guide rod, and an upper part of the hammer is provided with an iron ring which is connected to the hoisting mechanism 7310 through a wire rope and a pulley block such that the hammer 7303 is capable of being lifted and released. When the hammer 7303 is released and falls along the hammer guide rod 7301, the clamping force of the hydraulic cylinder of the hydraulic pile clamping part 7400 is reduced until the hammer 7303 hits the steel pile 7304 to ensure the steel pile 7304 to be smoothly hammered into the earth. After the hitting, the hoisting mechanism 7310 lifts the hammer 7303 to a certain height through the wire rope and then releases the hammer again, and the hitting process is repeated until the steel pile 7304 is driven into the earth.

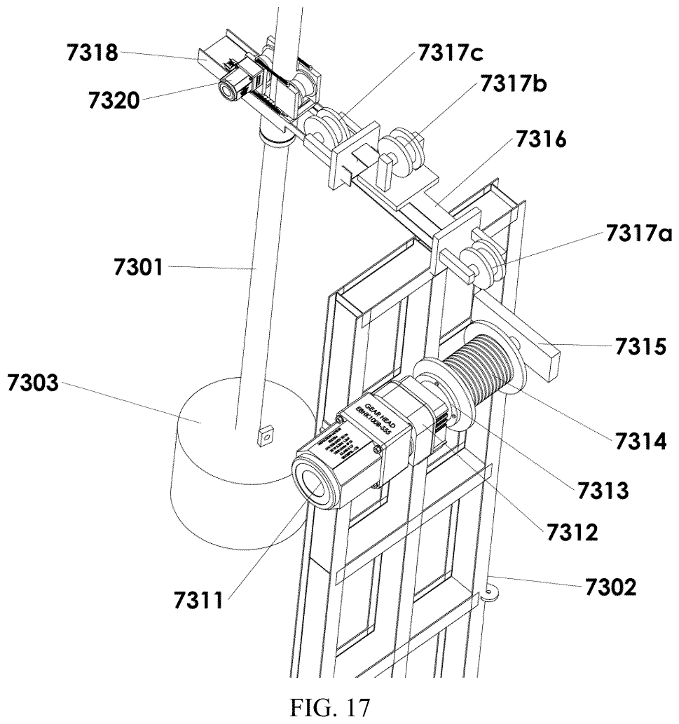

The hoisting mechanism 7310 includes a hydraulic motor a 7311, a reducer a 7312, an electromagnetic clutch 7313, a wire rope reel 7314, a reel fixing support 7315, a short I-beam a 7316, a pulley a 7317a, a pulley b 7317b, a pulley c 7317c, a short I-beam b 7318 and a linear bearing 7319. As shown in FIG. 17, the hydraulic motor a 7311 is provided with a hydraulic oil pressure by the hydraulic station a 6200 and converts the hydraulic oil pressure into a rotating motion, the hydraulic motor a 7311 is fixed to the steel frame 7302 through bolts, an output shaft of the hydraulic motor a is connected to an input shaft of the reducer a 7312, and the reducer a 7312 is mounted to a side surface of the hydraulic motor 7311 a through bolts. One side of the electromagnetic clutch 7313 is fixedly mounted to an output shaft of the reducer a 7312, the other side is fixedly mounted to a side surface of the wire rope reel 7314, the electromagnetic clutch 7313 controls whether power of the output shaft of the reducer a 7312 is outputted to the wire rope reel 7314 by controlling power engagement and disengagement of the clutch through closing and opening of an input circuit, the reel fixing support 7315 is fixed to the steel frame 7302 through bolts, and a ball bearing therein forms an interference fit with a rotating shaft of the wire rope reel 7314 to support and constrain the wire rope reel 7314 so as to ensure stable rotation of the wire rope reel. The short I-beam a 7316 is fixed to a top end of the steel frame 7302, the pulley a 7317a is fixed to an end portion of the short I-beam a 7316, the pulley b 7317b is fixed to a top of the short I-beam a 7316, a middle of the short I-beam b 7318 is provided with a circular hole which is used for fixing the linear bearing 7319 and for the hammer guide rod 7301 to run through, and a square hole which is used for fixing the pulley c 7317c and for the wire rope to run through, a flat surface of the short I-beam b 7318 faces up, and one end of the short I-beam b is fixed to an end portion of the short I-beam a 7316 by welding. The pulley c 7317c is fixed beside the square hole in the middle of the short I-beam b 7318 through bolts, the iron ring of the hammer 7303 is connected to the wire rope reel 7314 through the wire rope across the pulley c 7317c, the pulley b 7317b and the pulley a 7317a, and forward and reverse rotation of the wire rope reel 7314 are capable of winding up or releasing the wire rope such that the hammer 7303 is capable of rising and falling.

The linear bearing 7319 is fixed below the circular hole of the short I-beam b 7318 through bolts and configured to constrain the hammer guide rod 7301 to be only able to move up and down. The guide rod lifting mechanism 7320 is fixed above the circular hole in the middle of the short I-beam b 7318 and configured to control an upward/downward moving distance of the hammer guide rod 7301, to ensure a lower end of the hammer guide rod 7301 to be always in contact with the top of the steel pile 7304 during pile driving, thereby ensuring the hammer 7303 to be able to hammer the steel pile 7304. After the pile driving is completed, the hammer guide rod 7301 is lifted by the guide rod lifting mechanism 7320.

The specific working process is as follows:

The steel pile 7304 is vertically placed into a specified pile driving hole. The height of the hammer guide rod 7301 is adjusted through forward and reverse rotation of a hydraulic motor b 7321 of the guide rod lifting mechanism 7320 until the bottom contacts the top of the steel pile 7304. The hydraulic motor a 7311 keeps rotating normally all the time. When the electromagnetic clutch 7313 is switched off and engaged, power outputted by the hydraulic motor a 7311 is transmitted to the electromagnetic clutch 7313 after undergoing speed reduction and moment increasing by the reducer a 7312. The electromagnetic clutch 7313 transmits the power to the wire rope reel 7314, and the wire rope reel 7314 rotates forward to wind up the wire rope so as to lift the hammer 7303 to a certain height. When the electromagnetic clutch 7313 is switched on and disengaged, its power cannot be transmitted to the wire rope reel 7314, the gravity of the hammer 7303 pulls the wire rope, the wire rope transmits the pulling force to the wire rope reel 7314, the wire rope reel 7314 rotates reversely at a high speed to release the wire rope, the hammer 7303 falls at a high speed to hit the 7304, and this process is repeated, thereby achieving the effect of pile driving by hammering. Moreover, when the electromagnetic clutch 7313 is switched off and engaged, since the reducer a 7312 is a worm gear reducer, it has a self-locking function in case of reverse rotation. When the machine stops working or is suddenly de-energized, the self-locking function in case of reverse rotation of the reducer can restrict the hammer from falling, thereby preventing the hammer from falling suddenly and causing damage to equipment. The electromagnetic clutch 7313, which is engaged when switched off and disengaged when switched on, has a protection function.

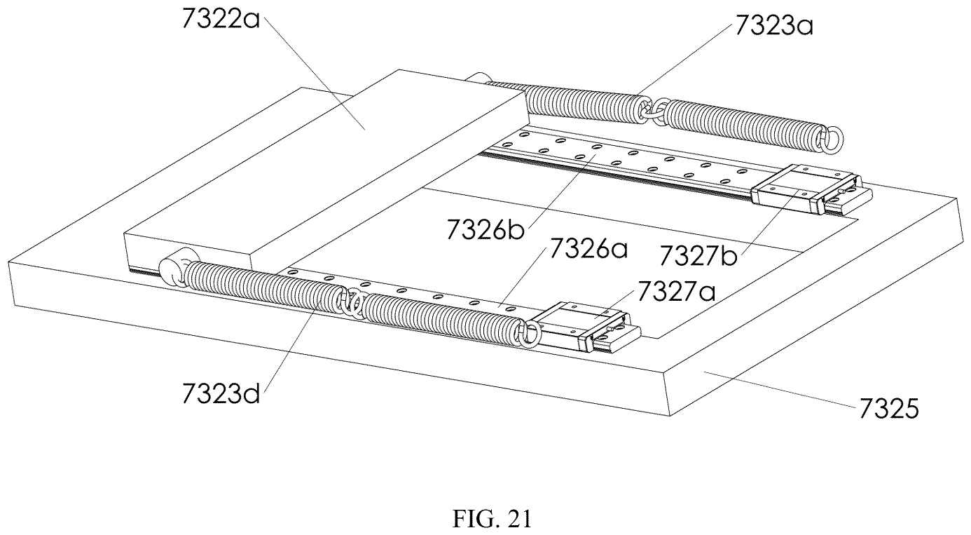

The guide rod lifting mechanism 7320 includes the hydraulic motor b 7321, a supporting plate a 7322a, a supporting plate b 7322b, a tension spring a 7323a, a tension spring b 7323b, a tension spring c 7323c, a tension spring d 7323d, a deep groove pulley a 7324a, a deep groove pulley b 7324b, a hollowed supporting plate 7325, a square slide rail a 7326a, a square slide rail b 7326b, a slider a 7327a and a slider b 7327b. The hollowed supporting plate 7325 has a structure as shown in FIG. 21, and is used as a base of the guide rod lifting mechanism 7320 and fixed above the circular hole in the middle of the short I-beam b 7318. The square slide rail a 7326a and the square slide rail b 7326b are fixed to two sides of the hollowed supporting plate 7325 through bolts, and the slider a 7327a and the slider b 7327b cooperating therewith are movable on the two slide rails along a length direction of the slide rails. The supporting plate a 7322a is fixed on tops of the square slide rail a 7326a and the square slide rail b 7326b through bolts. The supporting plate b 7322b is fixed on tops of the slider a 7327a and the slider b 7327b through bolts and is movable with the two sliders along the slide rails. Two ends of the supporting plate a 7322a and the supporting plate b 7322b have protruding cylinders which are used to be fixedly connected to two ends of the tension spring a 7323a and the tension spring d 7323d. Bases of the deep groove pulley a 7324a and the deep groove pulley b 7324b are respectively fixed on tops of the supporting plate b 7322b and the supporting plate a 7322a through bolts. The deep groove pulley a 7324a and the deep groove pulley b 7324b each include a base and a curved roller wheel. The curved roller wheel is made of rubber. A center of rotation of the curved roller wheel is connected to the base through a hinge pin, and a curved section on the roller wheel is arc-shaped and can be in close contact with a cylindrical surface of the hammer guide rod 7301. Tops of the bases of the deep groove pulley a 7324a and the deep groove pulley b 7324b are provided with cylindrical protrusions which are used to be fixedly connected to two ends of the tension spring b 7323b and the tension spring c 7323c. After running through the linear bearing 7319, the hammer guide rod 7301 is located between the roller wheels of the deep groove pulley a 7324a and the deep groove pulley b 7324b. The supporting plate b 7322b and the deep groove pulley a 7324a are subjected to pulling forces of the tension spring a 7323a, the tension spring b 7323b, the tension spring c 7323c and the tension spring d 7323d to move toward the hammer guide rod 7301. The roller wheel of the deep groove pulley b 7324b is subjected to the strong pulling forces of the four tension springs to squeeze the hammer guide rod 7301. The curved roller wheel made of rubber can be in close contact with the surface of the hammer guide rod 7301 and provide large friction. The hydraulic motor b 7321 is fixed to a side surface of the base of the deep groove pulley b 7324b through bolts, an output shaft of the hydraulic motor b is connected to a rotating shaft of the roller wheel of the deep groove pulley b 7324b, and the hydraulic motor b 7321 can drive the roller wheel of the deep groove pulley b 7324b to rotate synchronously. When the hydraulic motor b 7321 rotates forward and reversely, the roller wheel of the deep groove pulley b 7324b rotates forward and reversely, and the hammer guide rod 7301 can go up and down under the friction of the rotation of the roller wheel. Since the hammer 7303 slides along the hammer guide rod 7301, the diameter of the hammer guide rod 7301 changes after long time abrasion to the surface of the hammer guide rod. In this design, by using the tension springs to apply pressure, the flexible contact can solve the problem that the roller wheels of the deep groove pulley a 7324a and the deep groove pulley b 7324b cannot be in close contact with the hammer guide rod 7301 due to abrasion of the hammer guide rod 7301.

The hydraulic pile clamping part 7400 is hydraulically driven to clamp the steel pile 7304 so as to handle the steel pile and adjust a position of the steel pile, and the hydraulic pile clamping part mainly includes a hydraulic clamp base 7401, a hydraulic clamp oil cylinder hinge support 7402, a hydraulic clamp oil cylinder 7403, a curved steel jaw a 7405a, a curved steel jaw b 7405b and a centering clamping mechanism 7410. The hydraulic clamp base 7401 is a rectangular steel frame with a hollow space in a middle and is fixed to a top of the steel frame 7302 through bolts, the hydraulic clamp oil cylinder hinge support 7402 is fixed to an end portion of the hollow space in the middle of the hydraulic clamp base 7401, a cylinder tail of the hydraulic clamp oil cylinder 7403 is hinged with a pin hole of the hydraulic clamp oil cylinder hinge support 7402 through a hinge pin, and a retractable end of the hydraulic clamp oil cylinder is fixedly connected to one end of the curved steel jaw a 7405a through a Y-shaped joint. Extension and retraction of the hydraulic clamp oil cylinder 7403 are capable of driving the curved steel jaw a 7405a to move along an axial direction of the hydraulic cylinder, and force of the curved steel jaw a 7405 is transferred to the curved steel jaw b 7405b through the centering clamping mechanism 7410, such that the curved steel jaw b 7405b synchronously moves oppositely along the axial direction of the hydraulic cylinder, and thereby the curved steel jaw a 7405a and the curved steel jaw b 7405b move toward the center and clamp the steel pile.

The centering clamping mechanism 7410 includes a slide rod support a 7411a, a slide rod support b 7411b, a slide rod support c 7411c, a slide rod support d 7411d, a rod-type slider a 7412a, a rod-type slider b 7412b, a slide rod a 7413a, a slide rod b 7413b, a slide rod c 7413c, a slide rod d 7413d, a gear fixing support 7414, a gear 7415, a rack a 7416a, a rack b 7416b, a rack guide support a 7417a, a rack guide support b 7417b and an anti-collision rod 7418. The slide rod support a 7411a, the slide rod support b 7411b, the slide rod support c 7411c and the slide rod support d 7411d are fixed to two ends and a middle of a front side of the hydraulic clamp base 7401 and configured to fix the slide rod a 7413a, the slide rod b 7413b, the slide rod c 7413c and the slide rod d 7413d. The rod-type slider a 7412a and the rod-type slider b 7412b matched with the slide rods can only move along axial directions of the slide rod a 7413a and the slide rod c 7413c, and the slide rod b 7413b and the slide rod d 7413d. The gear fixing support 7414 is fixed to a middle position of the front side of the hydraulic clamp base 7401, a rotating shaft of the gear 7415 forms an interference fit with a bearing of the gear fixing support 7414, and the gear 7415 rotates freely around the rotating shaft. The rack guide support a 7417a and the rack guide support b 7417b have a same structure, with one end provided with direction openings for the racks to run through to constrain the racks to move along the axial directions of the slide rods and the other end fixedly connected to the racks, and are respectively fixed to inner sides of the curved steel jaw a 7405a and the curved steel jaw b 7405b. A right end of the rack a 7416a is fixedly connected to a lower part of the rack guide support b 7417b, and a left end runs through a square guide hole at a lower part of the rack guide support a 7417a. A left end of the rack b 7416b is fixedly connected to an upper part of the rack guide support a 7417a, and a right end runs through a square guide hole at an upper part of the rack guide support b 7417b. The rack a 7416a and the rack b 7416b respectively mesh with the gear 7415. The anti-collision rod 7418 is a steel cylinder whose left end is fixed to an inner side of the curved steel jaw a 7405a by welding, the curved steel jaw b 7405b is provided with a circular hole for the anti-collision rod 7418 to run through, the anti-collision rod 7418 is not interfered with when moving with the curved steel jaw a 7405a along the axial direction, and the anti-collision rod 7418 is configured to abut against the steel pile when the steel pile is clamped so as to prevent the steel pile from contacting the centering clamping mechanism 7410 and protect the centering clamping mechanism 7410.

The specific working process is as follows. The plurality of hydraulic pile clamping parts 7400 are fixed to the steel frame 7302. When the steel jaws are open, the multi-degree-of-freedom articulated arm 7200 is controlled to sleeve the steel jaws on the surface of the steel pile 7304. The hydraulic station a 6200 provides hydraulic power to the hydraulic clamp oil cylinder 7403 and controls the extension and retraction actions and pressure of the hydraulic clamp oil cylinder. When the hydraulic clamp oil cylinder 7403 retracts, the curved steel jaw a 7405a is driven to move toward the middle along the slide rod a 7413a and the slide rod c 7413c, and the rack guide support a 7417a moves together to drive the rack b 7416b to move together so as to drive the gear 7415 to rotate synchronously. When the gear 7415 rotates, the rack a 7416a is driven to move in a direction opposite to the rack b 7416b, and the rack a 7416a drives the rack guide support b 7417b to move toward the middle so as to further drive the curved steel jaw b 7405b to move toward the middle along the slide rod b 7413b and the slide rod d 7413d, thereby clamping the steel pile 7304. Thus, the steel pile can be handled, and the attitude of the steel pile can be adjusted. When the hydraulic clamp oil cylinder 7403 extends, the curved steel jaw a 7405a is driven to move to a side along the slide rod a 7413a, and the rack guide support a 7417a moves together to drive the rack b 7416b to move together so as to drive the gear 7415 to rotate synchronously. When the gear 7415 rotates, the rack a 7416a is driven to move in a direction opposite to the rack b 7416b, and the rack a 7416a drives the rack guide support b 7417b to move to a side so as to further drive the curved steel jaw b 7405b to move to a side, thereby opening the steel jaws and releasing the steel pile. The clamping force can be adjusted by adjusting the pressure of the hydraulic clamp oil cylinder 7403.

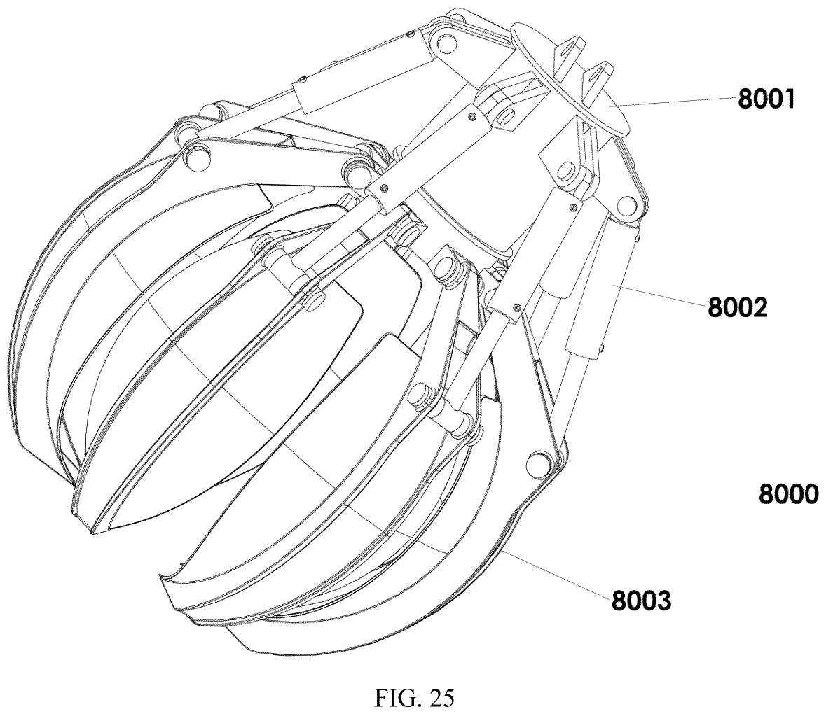

The hydraulic claw 8000 includes a hydraulic claw base 8001, hydraulic cylinders a 8002 and arc-shaped steel jaws 8003. The hydraulic claw base 8001 has lifting rings and hinge holes. A tail of the hydraulic cylinder a 8002 is hinged with the hydraulic claw base 8001 through a hinge pin, and a retractable end is hinged with a pin hole in a middle of the arc-shaped steel jaw 8003 through a hinge pin. A pin hole at an end portion of the arc-shaped steel jaw 8003 is hinged with a pin hole of the hydraulic claw base 8001. The plurality of hydraulic cylinders a 8002 and arc-shaped steel jaws 8003 are combined to form the structure as shown in FIG. 25. Extension and retraction actions of the plurality of hydraulic cylinders a 8002 are controlled to further control opening and closing of the arc-shaped steel jaws 8003. The hydraulic claw 8000, which is a mobile tower crane transportation claw, can be mounted on the lifting hook 5004 of the lifting platform, and can be driven by the hydraulic station to complete earth excavation and transportation in the construction area to realize earth and cargo transportation on rough ground.

The tower-wall concrete pouring system 9000 includes a fixed bottom plate 9001, hinge supports c 9002, a hydraulic station b 9003, a concrete pouring part 9010 and a concrete screw conveyor 9100. The fixed bottom plate 9001 is a steel plate. The hinge supports c 9002 have a same structure as the hinge supports b 7101, can be mounted on the carrying tower 6000 after being combined so as to realize quick mounting and removal, and can move along the standard sections of the carrying tower 6000. The hydraulic station b 9003 has a same structure as the hydraulic station a 6200 and provides power for actions of the tower-wall concrete pouring part 9010. The tower-wall concrete pouring system 9000 is movable on slide rails of the tower standard sections.

The concrete pouring part 9010 includes a four-legged base 9011, a hydraulic turntable 9012, a counterweight 9013, a concrete pump 9014, a concrete conveying duct 9015, an articulated boom 9016 and a hydraulic cylinder b 9017, the four-legged base 9011 is used as a base of the concrete pouring part 9010 and fixed to a top of the fixed bottom plate 9001 through bolts, and the hydraulic turntable 9012 is fixed to a top of the four-legged base 9011, has a same structure as a turntable of an excavator, and has functions of rotation and supporting. The articulated boom 9016 is a foldable cantilever, the concrete conveying duct 9015 is fixed to a side surface along the articulated boom 9016, and a structure formed is the same as a cantilever structure of a concrete pump truck. The counterweight 9013 is configured to counterbalance a moment of the cantilever when the cantilever is unfolded so as to ensure a relative balance of the tower, the concrete pump 9014 is powered from the tower crane, an input port of the concrete pump is connected to an output port of the concrete screw conveyor 9100 through a rubber hose and a concrete conveying steel pipe, the concrete conveying steel pipe is fixable to a side wall of a vertical tower and arranged along the tower standard sections, and the concrete pump 9014 and the concrete screw conveyor 9100 jointly pump concrete to the concrete conveying duct 9015 for pouring. When the concrete pouring part 9010 moves on the carrying tower 6000, the hydraulic turntable 9012 may be used to pour the concrete to different directions, which makes the pouring range wider without dead angles and makes the pouring more flexible.

The concrete screw conveyor 9100 includes a second motor 9101, a motor reducer 9102, a belt drive mechanism 9103, a screw shaft 9104, a concrete bin 9105, a ground conveying duct 9106 and a concrete discharge port 9107. The second motor 9101 is fixed to a side wall of the concrete bin 9105. The motor reducer 9102 is connected to the second motor 9101 through bolts. An output shaft of the second motor 9101 is connected to an input shaft of the motor reducer 9102. Power is subjected to speed reduction and moment increasing by the motor and transmitted to an input end of the screw shaft 9104 through the belt drive mechanism 9103 so as to drive the screw shaft 9104 to rotate. The screw shaft 9104 is fixed through a bearing and runs through the ground conveying duct 9106. The concrete discharge port 9107 is connected to the concrete conveying duct 9015. When the concrete is added to the concrete bin 9105, the screw shaft 9104 rotates to convey the concrete to the tower-wall concrete pouring system 9000 through the ground conveying duct 9106, the rubber hose and the concrete conveying steel pipe for pouring; and a plurality of concrete pumps 9014 connected in series are installed on a platform of a standard section tower according to a conveying height, thereby improving the conveying and pouring efficiency.

Correspondingly, the construction method using the expandable multifunctional integrated- construction skyscraper building platform provided by the disclosure includes the following steps:
S1: during transportation and construction on a surface of a building 0004, lowering a whole lifting platform part 2000 to a basement level 0002 or a ground level 0003, allowing construction robots or construction workers to enter a Chinese character “Hui” lifting platform 2001 to prepare for operations, lifting the lifting platform part 2000 to a specified floor, and allowing the construction robots to move and operate in tracks of the Chinese character “Hui” lifting platform 2001, where a number of the lifting platform parts 2000 may be increased according to needs to improve the efficiency;
S2: during internal transportation and construction on a top of the building 0004, lowering a transportation elevator part 3000 to the basement level 0002 or the ground level 0003, allowing the construction robots to enter construction elevators 3002, lifting the construction elevators to a height of an access aisle 4002, allowing the robots to enter the three-layer enclosure part 4000 through the aisle to perform building construction, and lowering the construction elevators 3002 for loop transportation, where the three-layer enclosure part 4000 is provided with three access aisles 4002 respectively corresponding to construction of three layers, and the robots with different functions are dispatched for construction operation according to needs of operation, maintenance and enclosure;
S3: during external transportation and construction on the top of the building 0004, placing required construction materials or prefabricated components 0005 in a lifting area formed by an external frame part 1000 in front of the building 0004, moving two gantry crane structures on a top of the external frame part 1000 to above the lifting area, lowering lifting hooks, locking the prefabricated components 0005, pulling the prefabricated components 0005 up to a specified height by winches such that the prefabricated components pass through the top of the building 0004 and reach a construction area of a Chinese character “Ri” frame, moving the two gantry crane structures to specified positions, placing the prefabricated components 0005 to specified positions on the top of the building 0004, repeating the above process for transportation and construction, and at the same time, using two auxiliary tower cranes 5005 on two sides of a top of the construction area of the Chinese character “Ri” frame to transfer light materials into the top of the building in real time 0004; and
S4: mounting a carrying tower 6000, a hammer-type pile driving system 7000, hydraulic claws 8000 and a tower-wall concrete pouring system 9000. The carrying tower 6000, the hammer-type pile driving system 7000, the hydraulic claws 8000 and the tower-wall concrete pouring system 9000 are all function modules of the lifting platform. The carrying tower 6000 is mainly configured to carry and fix the hammer-type pile driving system 7000 and the tower-wall concrete pouring system 9000. The hammer-type pile driving system 7000, which is a hydraulic pile driving system, is configured to clamp a steel pile, move the steel pile to the preset position and hammer the steel pile into the earth by means of a hammering part. The tower-wall concrete pouring system 9000 is mounted on tower standard sections 6100 and is capable of pumping concrete on the ground level to a construction area covered by the tower so as to perform pouring in place of a traditional pump truck. The hydraulic claw 8000, which is a mobile tower crane transportation claw, can be mounted on the lifting hook 5004 of the lifting platform, and can be driven by the hydraulic station to complete earth excavation and transportation in the construction area.

The foregoing descriptions are merely specific embodiments in the disclosure, but the scope of protection of the disclosure is not limited thereto. Any changes or substitutions that can be figured out by those skilled in the art within the technical scope disclosed by the disclosure shall fall into the scope of the disclosure.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. An extended multifunctional integrated construction aerial building platform, comprising:
a building chassis portion, consisting of three layers of ground, underground first layer, and ground, configured to serve as a bottom support of the entire platform;
an outer frame portion mounted on the building chassis portion, wherein a bottom portion of the outer frame portion can extend into the ground for fixing, and the upper portion of the outer frame portion passes through the underground layer, and the ground directly reaches the high altitude, so that the lifting platform portion disposed on the outer frame portion can be sequentially constructed from the bottom to the top;
a transportation elevator part mounted on the building chassis part and composed of a vertical rectangular frame enclosed by a fourth standard section, wherein two construction elevators are arranged inside the vertical side of the vertical rectangular frame, and can move on a track formed by the fourth standard section, thereby transporting people, robots and construction materials to a higher layer;
a three-layer enclosure portion mounted on the outer frame portion and composed of three-layer concentric-square-shaped enclosure baffles, a concentric-square-shaped bottom support plate being provided on an inner side of the three-layer return-type enclosure baffle, a concentric-square-shaped aisle being installed above the bottom support plate, a middle aisle and an access walkway being provided in the middle of the concentric-square-shaped aisle, and the construction elevator being able to reach the height of the access walkway;
a top adjusting part mounted on a Chinese character “ri” frame at the top of the outer frame part, a second sliding rail being provided on the left and right tracks of the Japanese-shaped frame, a moving trolley being provided on the second sliding rail, and a gantry crane structure formed by several fifth standard knots being provided on the moving trolley;
a carrier tower body mounted on the outer frame portion;
a hammering type pile sinking system mounted on the bearing tower body and used for clamping a steel pile, moving the steel pile to a predetermined position, and hammering the steel pile into the soil body through the hammering part;
a tower wall concrete pouring system mounted on the bearing tower body and used for pumping concrete on the ground to a construction area for concrete pouring.

20. The expanded multifunctional integrated construction aerial building platform according to claim 19, wherein the outer frame part is formed by six first standard sections and is mounted on the ground, and several second standard sections are mounted thereon; the six first standard sections divide the construction area into front and rear blocks, and each adjacent four first standard sections form a construction area, which is a building construction area and a material conveying area, respectively;
a vertical standard section vertical column composed of a plurality of third standard sections passes through the middle of the upper portion of the second standard section, and can move up and down through the actuating piece; the tops of the vertical standard section columns are connected by a transverse third standard section to form a Japanese-shaped frame; a first sliding rail is provided on the outer side of the vertical column composed of the second standard section, a winch is provided at the top of the second standard section, and a first supporting rod is provided on the inner side of the first sliding rail; two lifting platform parts are mounted on the first sliding rail and can be pulled on the first sliding rail by means of the winch for height adjustment; and the other end of the first supporting rod is fixed to the surface of the building, so that the whole outer frame part is attached to the building.

21. The expanded multifunctional integrated construction aerial building platform according to claim 20, wherein a middle cross-shaped aisle formed by the middle aisle and the in-out walkway can be arranged or detached in advance, and when the whole three-layer enclosure portion moves above the top of the building, the three-layer enclosure portion can be arranged, and when the three-layer enclosure portion moves to the lower portion, the three-layer enclosure portion can be detached, so that the three-layer enclosure portion can enclose the entire building inside for maintenance;
the three-layer back-type enclosure baffle sequentially comprises an operation layer, a maintenance layer and an enclosure layer from top to bottom, and the three-layer concentric enclosure baffle cooperates with the internal aisle, so that the building robot and the building material are transported from the bottom to the entrance/exit walkway through the transportation elevator part, and then enter the concentric-square-shaped aisle inside the three-layer back-type enclosure baffle to construct the building.

22. The extended multifunctional integrated construction aerial building platform according to claim 19, wherein the bearing tower body comprises a tower body standard section, a hydraulic station A, and an I-shaped steel slideway;
the hydraulic station A provides power for each oil cylinder of the hammering type pile sinking system, and is composed of an oil storage tank, a first motor, a controller, a hydraulic pump, an electromagnetic valve group and a servo valve, wherein the first motor is connected with a tower crane power supply through a wire to supply power, the hydraulic pump is driven to generate high-pressure hydraulic oil, and pressure and flow are adjusted through the servo valve;
the controller controls the on-off of the servo valve and the solenoid valve group in a remote control manner;
the I-shaped steel slideway is composed of a sliding rail trolley, a hinge support A, an I-shaped steel rail A and an I-shaped steel rail B; the I-shaped steel rail A and the I-shaped steel rail B are fixed to the side surface of the tower body standard joint by welding, the sliding rail trolley is mounted on the I-shaped steel rail A and the I-shaped steel rail B, and the base of the hinge support A is fixedly connected to the base of the sliding rail trolley through bolts.

23. The extended multifunctional integrated construction aerial building platform according to claim 19, wherein the hammering type pile sinking system comprises a connecting support, a multi-degree-of-freedom articulated arm, a hammering part, and a hydraulic clamping pile part;
the connecting support is configured to support and fix the multi-degree-of-freedom joint arm to ensure stable movement of the hammering type pile sinking system;
the multi-degree-of-freedom articulated arm drives each joint arm to complete a corresponding action by means of a hydraulic cylinder;
the hammering part lifts the heavy hammer by means of a hydraulic winch, and the heavy hammer releases the hammering steel pile, so as to perform reciprocating circulation, and the heavy hammer continuously hammering the steel pile to complete the pile sinking process;
the hydraulic clamping pile portion is operated at the same time, the hydraulic cylinder drives the clamping mechanism to clamp the steel pile, the multi-degree-of-freedom joint arm is controlled to move the steel pile and adjust the orientation, the steel pile is stably inserted into the foundation pit, the clamping force of the hydraulic cylinder of the hydraulic clamping pile portion is reduced, and it is ensured that the steel pile smoothly sinks into the soil body during hammering.

24. The extended multifunctional integrated construction aerial building platform according to claim 23, wherein the connecting support comprises a hinge support B, a support steel plate, a swing arm hydraulic cylinder A, a swing arm hydraulic cylinder B, a heavy hinge support, and a U-shaped swing arm, wherein the support steel plate serves as a basic base of a hammering type pile sinking system, the hinge support B is fixed on the back surface of the support steel plate, the axes of pin holes of the two rows of hinge supports B are perpendicular to each other, and are connected to the hinge support A through a pin shaft;
the heavy hinge support is welded and fixed to the middle position of the front surface of the support steel plate, and can bear the overall weight of the hammering type pile sinking system; the pin hole at one end of the U-shaped swing arm is connected to the heavy hinge support by means of a pin shaft, and two sides of the U-shaped swing arm are respectively hinged to the telescopic ends of the swing arm hydraulic oil cylinder A and the swing arm hydraulic oil cylinder B;
the cylinder tail of the swing arm hydraulic cylinder A and the swing arm hydraulic cylinder B are connected to pin hole seats fixed to two sides of the support steel plate by means of a pin shaft, and the U-shaped swing arm is controlled to rotate along the pin hole axis of the heavy hinge support by means of the swing arm hydraulic cylinder A and the swing arm hydraulic cylinder B, thereby realizing left-right rotation of the multi-degree-of-freedom joint arm.

25. The extended multifunctional integrated construction aerial building platform according to claim 24, wherein the multi-degree-of-freedom articulated arm comprises a joint arm cylinder hinge seat A, a joint arm cylinder A, a first joint arm, a joint arm cylinder hinge seat B, a joint arm cylinder B, a second joint arm, a joint arm cylinder C, an arc-shaped connecting rod, a linear connecting rod, and a steel plate, the articulated arm cylinder hinge base A is welded and fixed to the upper part of the U-shaped swing arm, the articulated arm cylinder hinge base A can rotate along with the U-shaped swing arm, one end pin hole of the first joint arm is hinged to the lower pin hole of the joint arm cylinder hinge base A through a pin shaft, the pin hole at the other end is hinged to the pin hole of the second joint arm through a pin shaft, and meanwhile, the pin hole in the upper part of the first joint arm is hinged to the telescopic end of the joint arm cylinder A through a pin shaft;
the tail portion of the cylinder body of the joint arm cylinder A is hinged to the upper pin hole of the joint arm cylinder hinge base A through a pin shaft, and the telescopic control of the joint arm cylinder A controls the lifting action of the first joint arm; the joint arm oil cylinder hinge base B is welded and fixed below the first joint arm, the cylinder tail portion of the joint arm oil cylinder B is hinged to the end pin hole of the joint arm oil cylinder hinge base B through a pin shaft, the telescopic end of the joint arm oil cylinder B is hinged to the lower pin hole of the second joint arm through a pin shaft, and the telescopic control of the joint arm oil cylinder B controls the lifting action of the second joint arm;
the upper pin hole of the second joint arm is hinged to the cylinder tail of the joint arm oil cylinder C by means of a pin shaft, the telescopic end of the joint arm oil cylinder C is hinged to the arc-shaped connecting rod and one end pin hole of the linear connecting rod through a pin shaft, the other pin hole of the arc-shaped connecting rod is hinged to the middle pin hole of the second joint arm through a pin shaft, the other pin hole of the linear connecting rod is hinged to the upper pin hole of the steel plate through a pin shaft, and the telescopic control steel plate of the joint arm oil cylinder C controls the pitching action of the steel plate.

26. The extended multifunctional integrated construction aerial building platform according to claim 25, wherein the hammering part comprises a heavy hammer guide rod, a steel frame, a heavy hammer, a steel pile, a winch structure, and a guide rod lifting mechanism; the steel frame serves as a fixed base of a hammering type pile sinking system, the heavy hammer guide rod is an alloy long rod piece, passes through the guide rod lifting mechanism, and controls the lifting height by the guide rod lifting mechanism;
the heavy hammer is a steel cylinder, a round hole is formed in the center of the heavy hammer, linear bearings are installed at the two ends of the round hole and penetrate through the heavy hammer guide rod and can slide up and down, an iron ring is arranged on the upper portion of the heavy hammer, and when the heavy hammer is released and falls along the heavy hammer guide rod, the heavy hammer can be lifted and released until the heavy hammer impacts the steel pile, and after the heavy hammer impacts the steel pile, the winch mechanism lifts the heavy hammer to a certain height again through the steel wire rope to sequentially circulate and impact until the steel pile is driven into the soil body;
the winch mechanism comprises a hydraulic motor A, a speed reducer A, an electromagnetic clutch, a steel wire rope reel, a reel fixing support, a short I-steel A, a pulley A, a pulley B, a pulley C, a short I-steel B, and a linear bearing
one side of the electromagnetic clutch is fixedly installed on the output shaft of the speed reducer A, the other side of the electromagnetic clutch is fixedly installed on the side face of the steel wire rope winding drum, the electromagnetic clutch controls whether the power of the output shaft of the speed reducer A is output to the steel wire rope winding drum through the closing and interruption of the input circuit, the winding drum fixing support is fixed on the steel frame through a bolt, and the ball bearing in the winding drum fixing support is in interference fit with the rotating shaft of the steel wire rope winding drum for supporting and constraining the steel wire rope winding drum to ensure stable rotation;
the short I-shaped steel A is fixed at the top end of the steel frame, the pulley A is fixed at the end of the short I-shaped steel A, the pulley B is fixed at the top of the short I-shaped steel A, a round hole is formed in the middle of the short I-steel B for fixing the linear bearing and passing through the heavy hammer guide rod, the square hole of the short I-steel B is used for fixing the pulley C and passing through the steel wire rope, the plane of the short I-shaped steel B faces upwards, and one end of the short I-steel B is fixed to the end of the short I-shaped steel A by welding;
the pulley C is fixed beside the middle square hole of the short I-shaped steel B through a bolt, the iron ring of the heavy hammer crosses the pulley C and the pulley B through the steel wire rope, the pulley A is connected with the steel wire rope winding drum, and forward and reverse rotation of the steel wire rope winding drum can wind up or release the steel wire rope, thereby realizing rising and falling of the heavy hammer;
the hydraulic pile clamping part clamps the steel pile in a hydraulic driving manner to adjust the transportation and position of the steel pile, and comprises a hydraulic clamp base, a hydraulic clamp cylinder hinge support, a hydraulic clamp cylinder, a cambered surface steel claw A, a cambered surface steel claw B, and a centering clamping mechanism; the hydraulic clamp base is a middle hollowed-out cuboid steel frame, and is fixed above the steel frame through bolts; the hydraulic clamp cylinder hinge support is fixed to the end of the hollow space in the middle of the hydraulic clamp base through bolts, and the cylinder tail of the hydraulic clamp cylinder is hinged to the pin hole of the hydraulic clamp cylinder hinge support through a pin shaft, and the telescopic end of the hydraulic clamp cylinder is fixedly connected to one end of the cambered surface steel claw A through a Y-shaped joint; telescopic of the hydraulic clamping cylinder can drive the cambered surface steel claw A to move in the axial direction of the hydraulic cylinder, and the cambered surface steel claw A transmits force to the cambered surface steel claw B through the centering clamping mechanism, so that the cambered surface steel claw B synchronously moves reversely in the axial direction of the hydraulic cylinder to achieve the effect of moving and clamping the cambered surface steel claw A and the cambered surface steel claw B;
the anti-collision rod is a steel cylinder, the left end of the anti-collision rod is fixed to the inner side of the cambered surface steel claw A through welding, the arc surface steel claw B is provided with a round hole through which the anti-collision rod passes, the anti-collision rod is not interfered with when the arc surface steel claw A moves axially, the anti-collision rod is used for abutting against the steel pile when the steel pile is clamped, the steel pile is prevented from making contact with the centering clamping mechanism, and the centering clamping mechanism is protected.

27. The expanded multifunctional integrated construction aerial building platform according to claim 19, wherein the tower wall concrete pouring system comprises a fixed bottom plate, a hinged support C, a hydraulic station B, a concrete pouring part and a concrete auger conveyor, the hydraulic station B provides power for the action of the tower wall type concrete pouring part, and the tower wall type concrete pouring system can move on the sliding rail of the tower body standard section;
the concrete pouring part comprises a four-foot base, a hydraulic rotary disk, a counterweight block, a concrete pump, a concrete conveying pipe, a folding arm, and a hydraulic cylinder B; the four-foot base serves as a base of the concrete pouring part and is fixed above the fixed bottom plate by bolts
the folding arm is a foldable cantilever, the concrete conveying pipeline is fixed to the side surface along the folding arm, and the formed structure is the same as the cantilever structure of the concrete pump truck; when the counterweight block is used for cantilever unfolding, the moment of the cantilever is balanced, the relative balance of the tower body is ensured, the concrete pump is connected to the output port of the concrete auger conveyor through the rubber hose and the concrete conveying steel pipe, the concrete conveying steel pipe can be fixed to the side wall of the vertical tower body, and the concrete pump and the concrete auger conveyor jointly pump concrete to the concrete conveying pipeline for pouring;
the concrete auger conveyor comprises a second motor, a motor speed reducer, a belt transmission mechanism, a spiral rotating shaft, a concrete material bin, a ground conveying pipeline, and a concrete discharging port; an output shaft of the second motor is connected to an input shaft of the motor speed reducer.

28. A construction method of the extended multifunctional integrated construction aerial building platform according to claim 19, characterized in that, the method comprises the following steps:
S1, when the surface of the building is transported and constructed, the whole lifting platform part is reduced to the underground first layer or the ground, the building robot or the construction worker enters the concentric-square-shaped lifting platform to prepare for operation, the lifting platform part is lifted to the designated floor, and the building robot moves in the track of the concentric-square-shaped lifting platform;
S2, when internal transportation construction is performed on the top of the building, the transportation elevator part is lowered to the underground first layer or the ground, so that the building robot enters the construction elevator and rises to the height of the access walkway, the robot enters the three-layer enclosure part through the walkway to perform building construction, the construction elevator descends for cyclic transportation, and the three-layer enclosure part is provided with three in-out walkways which respectively correspond to three-layer construction, and the robot with different functions can be constructed for construction operation according to operation, maintenance and enclosure;
S3, when the top of the building is subjected to external transportation construction, the required building material or prefabricated component is arranged in a lifting area enclosed by an outer frame part in front of the building, the two groups of gantry crane structures at the top of the external frame part are moved to the upper part of the lifting area, the lifting hook is put down to lock the prefabricated part, the prefabricated part is pulled up to the designated position through the winch structure, the prefabricated part is placed to the designated position after moving to the designated position, the prefabricated part is placed to the designated position of the top of the building, and then the prefabricated part is placed on the top of the building in real time by cooperating with the two auxiliary tower cranes on the two sides of the top of the construction area of the Japanese-shaped frame;
S4, installing a bearing tower body, a hammering type pile sinking system, a hydraulic claw and a tower wall type concrete pouring system, wherein the bearing tower body is used for bearing and fixing a hammering type pile sinking system and a tower wall type concrete pouring system, the hammering type pile sinking system is used for clamping a steel pile, moving the steel pile to a preset position, and hammering the steel pile into the soil body through the hammering part; the tower wall type concrete pouring system is installed on the tower body standard section, and can pump concrete on the ground to a construction area covered by the tower body to replace a traditional pump truck for pouring; and the hydraulic claw is installed on the lifting hook of the hoisting platform and cooperates with and drives the hydraulic claw by the hydraulic station to complete soil excavation and transfer work in the construction area.

29. The construction method according to claim 28, wherein in the expanded multifunctional integrated construction aerial building platform, the outer frame part is formed by six first standard sections and is mounted on the ground, and several second standard sections are mounted thereon; the six first standard sections divide the construction area into front and rear blocks, and each adjacent four first standard sections form a construction area, which is a building construction area and a material conveying area, respectively;
a vertical standard section vertical column composed of a plurality of third standard sections passes through the middle of the upper portion of the second standard section, and can move up and down through the actuating piece; the tops of the vertical standard section columns are connected by a transverse third standard section to form a Japanese-shaped frame; a first sliding rail is provided on the outer side of the vertical column composed of the second standard section, a winch is provided at the top of the second standard section, and a first supporting rod is provided on the inner side of the first sliding rail; two lifting platform parts are mounted on the first sliding rail and can be pulled on the first sliding rail by means of the winch for height adjustment; and the other end of the first supporting rod is fixed to the surface of the building, so that the whole outer frame part is attached to the building.

30. The construction method according to claim 29, wherein in the expanded multifunctional integrated construction aerial building platform, a middle cross-shaped aisle formed by the middle aisle and the in-out walkway can be arranged or detached in advance, and when the whole three-layer enclosure portion moves above the top of the building, the three-layer enclosure portion can be arranged, and when the three-layer enclosure portion moves to the lower portion, the three-layer enclosure portion can be detached, so that the three-layer enclosure portion can enclose the entire building inside for maintenance;
the three-layer back-type enclosure baffle sequentially comprises an operation layer, a maintenance layer and an enclosure layer from top to bottom, and the three-layer concentric enclosure baffle cooperates with the internal aisle, so that the building robot and the building material are transported from the bottom to the entrance/exit walkway through the transportation elevator part, and then enter the concentric-square-shaped aisle inside the three-layer back-type enclosure baffle to construct the building.

31. The construction method according to claim 28, wherein in the expanded multifunctional integrated construction aerial building platform, the bearing tower body comprises a tower body standard section, a hydraulic station A, and an I-shaped steel slideway;
the hydraulic station A provides power for each oil cylinder of the hammering type pile sinking system, and is composed of an oil storage tank, a first motor, a controller, a hydraulic pump, an electromagnetic valve group and a servo valve, wherein the first motor is connected with a tower crane power supply through a wire to supply power, the hydraulic pump is driven to generate high-pressure hydraulic oil, and pressure and flow are adjusted through the servo valve;
the controller controls the on-off of the servo valve and the solenoid valve group in a remote control manner;
the I-shaped steel slideway is composed of a sliding rail trolley, a hinge support A, an I-shaped steel rail A and an I-shaped steel rail B; the I-shaped steel rail A and the I-shaped steel rail B are fixed to the side surface of the tower body standard joint by welding, the sliding rail trolley is mounted on the I-shaped steel rail A and the I-shaped steel rail B, and the base of the hinge support A is fixedly connected to the base of the sliding rail trolley through bolts.

32. The construction method according to claim 28, wherein in the expanded multifunctional integrated construction aerial building platform, the hammering type pile sinking system comprises a connecting support, a multi-degree-of-freedom articulated arm, a hammering part, and a hydraulic clamping pile part;
the connecting support is configured to support and fix the multi-degree-of-freedom joint arm to ensure stable movement of the hammering type pile sinking system;
the multi-degree-of-freedom articulated arm drives each joint arm to complete a corresponding action by means of a hydraulic cylinder;
the hammering part lifts the heavy hammer by means of a hydraulic winch, and the heavy hammer releases the hammering steel pile, so as to perform reciprocating circulation, and the heavy hammer continuously hammering the steel pile to complete the pile sinking process;
the hydraulic clamping pile portion is operated at the same time, the hydraulic cylinder drives the clamping mechanism to clamp the steel pile, the multi-degree-of-freedom joint arm is controlled to move the steel pile and adjust the orientation, the steel pile is stably inserted into the foundation pit, the clamping force of the hydraulic cylinder of the hydraulic clamping pile portion is reduced, and it is ensured that the steel pile smoothly sinks into the soil body during hammering.

33. The construction method according to claim 32, wherein in the expanded multifunctional integrated construction aerial building platform, the connecting support comprises a hinge support B, a support steel plate, a swing arm hydraulic cylinder A, a swing arm hydraulic cylinder B, a heavy hinge support, and a U-shaped swing arm, wherein the support steel plate serves as a basic base of a hammering type pile sinking system, the hinge support B is fixed on the back surface of the support steel plate, the axes of pin holes of the two rows of hinge supports B are perpendicular to each other, and are connected to the hinge support A through a pin shaft;
the heavy hinge support is welded and fixed to the middle position of the front surface of the support steel plate, and can bear the overall weight of the hammering type pile sinking system; the pin hole at one end of the U-shaped swing arm is connected to the heavy hinge support by means of a pin shaft, and two sides of the U-shaped swing arm are respectively hinged to the telescopic ends of the swing arm hydraulic oil cylinder A and the swing arm hydraulic oil cylinder B;
the cylinder tail of the swing arm hydraulic cylinder A and the swing arm hydraulic cylinder B are connected to pin hole seats fixed to two sides of the support steel plate by means of a pin shaft, and the U-shaped swing arm is controlled to rotate along the pin hole axis of the heavy hinge support by means of the swing arm hydraulic cylinder A and the swing arm hydraulic cylinder B, thereby realizing left-right rotation of the multi-degree-of-freedom joint arm.

34. The construction method according to claim 33, wherein in the expanded multifunctional integrated construction aerial building platform, the multi-degree-of-freedom articulated arm comprises a joint arm cylinder hinge seat A, a joint arm cylinder A, a first joint arm, a joint arm cylinder hinge seat B, a joint arm cylinder B, a second joint arm, a joint arm cylinder C, an arc-shaped connecting rod, a linear connecting rod, and a steel plate, the articulated arm cylinder hinge base A is welded and fixed to the upper part of the U-shaped swing arm, the articulated arm cylinder hinge base A can rotate along with the U-shaped swing arm, one end pin hole of the first joint arm is hinged to the lower pin hole of the joint arm cylinder hinge base A through a pin shaft, the pin hole at the other end is hinged to the pin hole of the second joint arm through a pin shaft, and meanwhile, the pin hole in the upper part of the first joint arm is hinged to the telescopic end of the joint arm cylinder A through a pin shaft;
the tail portion of the cylinder body of the joint arm cylinder A is hinged to the upper pin hole of the joint arm cylinder hinge base A through a pin shaft, and the telescopic control of the joint arm cylinder A controls the lifting action of the first joint arm; the joint arm oil cylinder hinge base B is welded and fixed below the first joint arm, the cylinder tail portion of the joint arm oil cylinder B is hinged to the end pin hole of the joint arm oil cylinder hinge base B through a pin shaft, the telescopic end of the joint arm oil cylinder B is hinged to the lower pin hole of the second joint arm through a pin shaft, and the telescopic control of the joint arm oil cylinder B controls the lifting action of the second joint arm;
the upper pin hole of the second joint arm is hinged to the cylinder tail of the joint arm oil cylinder C by means of a pin shaft, the telescopic end of the joint arm oil cylinder C is hinged to the arc-shaped connecting rod and one end pin hole of the linear connecting rod through a pin shaft, the other pin hole of the arc-shaped connecting rod is hinged to the middle pin hole of the second joint arm through a pin shaft, the other pin hole of the linear connecting rod is hinged to the upper pin hole of the steel plate through a pin shaft, and the telescopic control steel plate of the joint arm oil cylinder C controls the pitching action of the steel plate.

35. The construction method according to claim 34, wherein in the expanded multifunctional integrated construction aerial building platform, the hammering part comprises a heavy hammer guide rod, a steel frame, a heavy hammer, a steel pile, a winch structure, and a guide rod lifting mechanism; the steel frame serves as a fixed base of a hammering type pile sinking system, the heavy hammer guide rod is an alloy long rod piece, passes through the guide rod lifting mechanism, and controls the lifting height by the guide rod lifting mechanism;
the heavy hammer is a steel cylinder, a round hole is formed in the center of the heavy hammer, linear bearings are installed at the two ends of the round hole and penetrate through the heavy hammer guide rod and can slide up and down, an iron ring is arranged on the upper portion of the heavy hammer, and when the heavy hammer is released and falls along the heavy hammer guide rod, the heavy hammer can be lifted and released until the heavy hammer impacts the steel pile, and after the heavy hammer impacts the steel pile, the winch mechanism lifts the heavy hammer to a certain height again through the steel wire rope to sequentially circulate and impact until the steel pile is driven into the soil body;
the winch mechanism comprises a hydraulic motor A, a speed reducer A, an electromagnetic clutch, a steel wire rope reel, a reel fixing support, a short I-steel A, a pulley A, a pulley B, a pulley C, a short I-steel B, and a linear bearing
one side of the electromagnetic clutch is fixedly installed on the output shaft of the speed reducer A, the other side of the electromagnetic clutch is fixedly installed on the side face of the steel wire rope winding drum, the electromagnetic clutch controls whether the power of the output shaft of the speed reducer A is output to the steel wire rope winding drum through the closing and interruption of the input circuit, the winding drum fixing support is fixed on the steel frame through a bolt, and the ball bearing in the winding drum fixing support is in interference fit with the rotating shaft of the steel wire rope winding drum for supporting and constraining the steel wire rope winding drum to ensure stable rotation;
the short I-shaped steel A is fixed at the top end of the steel frame, the pulley A is fixed at the end of the short I-shaped steel A, the pulley B is fixed at the top of the short I-shaped steel A, a round hole is formed in the middle of the short I-steel B for fixing the linear bearing and passing through the heavy hammer guide rod, the square hole of the short I-steel B is used for fixing the pulley C and passing through the steel wire rope, the plane of the short I-shaped steel B faces upwards, and one end of the short I-steel B is fixed to the end of the short I-shaped steel A by welding;
the pulley C is fixed beside the middle square hole of the short I-shaped steel B through a bolt, the iron ring of the heavy hammer crosses the pulley C and the pulley B through the steel wire rope, the pulley A is connected with the steel wire rope winding drum, and forward and reverse rotation of the steel wire rope winding drum can wind up or release the steel wire rope, thereby realizing rising and falling of the heavy hammer;
the hydraulic pile clamping part clamps the steel pile in a hydraulic driving manner to adjust the transportation and position of the steel pile, and comprises a hydraulic clamp base, a hydraulic clamp cylinder hinge support, a hydraulic clamp cylinder, a cambered surface steel claw A, a cambered surface steel claw B, and a centering clamping mechanism; the hydraulic clamp base is a middle hollowed-out cuboid steel frame, and is fixed above the steel frame through bolts; the hydraulic clamp cylinder hinge support is fixed to the end of the hollow space in the middle of the hydraulic clamp base through bolts, and the cylinder tail of the hydraulic clamp cylinder is hinged to the pin hole of the hydraulic clamp cylinder hinge support through a pin shaft, and the telescopic end of the hydraulic clamp cylinder is fixedly connected to one end of the cambered surface steel claw A through a Y-shaped joint; telescopic of the hydraulic clamping cylinder can drive the cambered surface steel claw A to move in the axial direction of the hydraulic cylinder, and the cambered surface steel claw A transmits force to the cambered surface steel claw B through the centering clamping mechanism, so that the cambered surface steel claw B synchronously moves reversely in the axial direction of the hydraulic cylinder to achieve the effect of moving and clamping the cambered surface steel claw A and the cambered surface steel claw B;
the anti-collision rod is a steel cylinder, the left end of the anti-collision rod is fixed to the inner side of the cambered surface steel claw A through welding, the arc surface steel claw B is provided with a round hole through which the anti-collision rod passes, the anti-collision rod is not interfered with when the arc surface steel claw A moves axially, the anti-collision rod is used for abutting against the steel pile when the steel pile is clamped, the steel pile is prevented from making contact with the centering clamping mechanism, and the centering clamping mechanism is protected.

36. The construction method according to claim 28, wherein in the expanded multifunctional integrated construction aerial building platform, the tower wall concrete pouring system comprises a fixed bottom plate, a hinged support C, a hydraulic station B, a concrete pouring part and a concrete auger conveyor, the hydraulic station B provides power for the action of the tower wall type concrete pouring part, and the tower wall type concrete pouring system can move on the sliding rail of the tower body standard section;
the concrete pouring part comprises a four-foot base, a hydraulic rotary disk, a counterweight block, a concrete pump, a concrete conveying pipe, a folding arm, and a hydraulic cylinder B; the four-foot base serves as a base of the concrete pouring part and is fixed above the fixed bottom plate by bolts
the folding arm is a foldable cantilever, the concrete conveying pipeline is fixed to the side surface along the folding arm, and the formed structure is the same as the cantilever structure of the concrete pump truck; when the counterweight block is used for cantilever unfolding, the moment of the cantilever is balanced, the relative balance of the tower body is ensured, the concrete pump is connected to the output port of the concrete auger conveyor through the rubber hose and the concrete conveying steel pipe, the concrete conveying steel pipe can be fixed to the side wall of the vertical tower body, and the concrete pump and the concrete auger conveyor jointly pump concrete to the concrete conveying pipeline for pouring;
the concrete auger conveyor comprises a second motor, a motor speed reducer, a belt transmission mechanism, a spiral rotating shaft, a concrete material bin, a ground conveying pipeline, and a concrete discharging port; an output shaft of the second motor is connected to an input shaft of the motor speed reducer.
